(19) United States
(12) Patent Application Publication
(10) Pub. No.: US 2014/0065060 A1
(43) Pub. Date: Mar. 6, 2014

(54) Precursors for Metal Organic Chemical Vapor Deposition Processes and Their Use

(71) Applicants: Karlsruher Institut fur Technologie (KIT), Karlsruhe (DE); BASF SE, Ludwigshafen (DE)

(72) Inventors: Wolfgang Gerlinger, Limburgerhof (DE); Bernd Sachweh, Meckenheim (DE); Stefan Bräse, Troisdorf (DE); Mirja Enders, Karlsruhe (DE); Thierry Müller, Karlsruhe (DE); Gerhard Kasper, Karlsruhe (DE); Martin Seipenbusch, Karlsruhe (DE); Kun Gao, Karlsruhe (DE); Matthias Faust, Karlsruhe (DE); Linus Reichenbach, Aachen (DE)

(73) Assignees: Karlsruher Institut fur Technologie (KIT), Karlsruhe (DE); BASF SE, Ludwigshafen (DE)

(21) Appl. No.: 14/013,700

(22) Filed: Aug. 29, 2013

Related U.S. Application Data
(60) Provisional application No. 61/695,440, filed on Aug. 31, 2012.

(51) Int. Cl. B01J 23/42; C07F 17/02

(52) U.S. Cl. CPC B01J 23/42; C07F 17/02
USPC 423/659; 556/136; 502/339; 502/262; 502/10

(57) ABSTRACT

The present invention relates to a compound of the general formula (I)

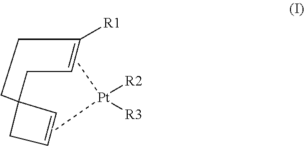

wherein R1 represents a group selected from the list consisting of methyl, ethyl, n-propyl, isopropyl, n-butyl, sec-butyl, tert-butyl, linear or branched, saturated or mono- or polyunsaturated aliphatic carbon chain containing from two to ten carbon atoms, phenyl, and phenylacetylen, and wherein R2 and R3 independently of each other represent a group selected from the list consisting of Cl, I, methyl, phenyl, or phenylacetylene.

### CROSS-REFERENCE TO RELATED APPLICATIONS

This application claims priority under 35 U.S.C. §119(e) to U.S. provisional Application No. 61/695,440, filed Aug. 31, 2012, the disclosure of which is incorporated herein by reference in its entirety.

### BACKGROUND OF THE INVENTION

The present invention relates to a compound of the general formula (I)

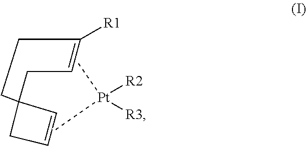

and a use of the compound as a precursor in a metal organic chemical vapor deposition process (MOCVD) for depositing platinum onto a substrate, a method of depositing platinum onto a substrate, and a substrate having one or more platinum dots on its surface. The invention further relates to a catalyst system comprising or consisting of a substrate having one or more platinum dots its surface, and a use of a substrate having one or more platinum dots on its surface as a catalyst system.

Further aspects and advantages of the present invention will become apparent from the ensuing description including the examples and the figures as well as from the enclosed patent claims.

The CVD (chemical vapor deposition) process is known as a coating method. It is among the most important processes in thin film technology. The CVD process is mainly used in the production of functional materials such as optical waveguides, insulators, semiconductors, conductor strips and layers of hard materials. In this process, molecular precursors transported in the gas phase react on hot surfaces in the reactor to form adherent coatings. Gas phase methods derived from metal organic chemical vapor deposition (MOCVD) have been used for the synthesis of catalysts, and show certain advantages since interfering salts and stabilizers are not present.

Overviews of the principle and applications of the CVD technique may be found, for example, in the following references: A. Fischer, Chemie in unserer Zeit 1995, 29, No. 3, pp. 141-152; Weber, Spektrum der Wissenschaft, April 1996, 86-90; L. Hitchman, K. F. Jensen, Acad. Press, New York, 1993 and M. J. Hampden-smith, T. T. Kodas, The Chemistry of Metal CVD, VCH, Weinheim, 1994.

The principle of MOCVD is that of vaporizing a volatile precursor of the metal, namely an organometallic complex, which decomposes thermally on the substrate to form a metallic layer. In practice, the vaporization takes place under pressure and temperature conditions that make it possible to obtain a sufficient precursor vapor pressure for the deposit, while at the same time the precursor remains within its stability range. As regards the substrate, it is heated beyond this stability range, which allows decomposition of the organometallic complex and the formation of metal particles. The MOCVD deposition method has various advantages over other known methods: the thermolysis temperature in MOCVD is typically 1000 to 2000 K lower than for other vapor deposition techniques not using organometallic complexes. The films obtained with MOCVD are dense and usually continuous. E.g., in contrast with liquid impregnation methods, MOCVD is rapid, and impregnation, washing, drying, purification and activation steps are avoided. Poisoning of the surface of the deposited layer, and modifications of the product during drying are also avoided. MOCVD is thus a controllable, rapid and economical method for obtaining high quality metal layers on a substrate.

Various organometallic platinum compounds, i.e. complexes containing platinum and organic ligands, are currently widely used. Examples are: Pt(acac)₂, Pt(PF₃)₄, (COD)PtMe₂, MeCpPtMe₃ and EtCpPtMe₃.

JP 08-157490 A discloses the use of diethyl-η⁴-(1,5-dimethylcycloocta-1,5-dien)platinum and diethyl-η⁴-(1,6-dimethylcycloocta-1,5-dien)platinum as precursors for use in the metal organic chemical vapor deposition method (MOCVD method). The organometallic precursors are used for the formation of thin platinum films which are useful as an electrode for dielectric memories of a semiconductor device. The 1,5-cyclooctadien ligand of the described compounds contains two substituents and therefore the precursor possesses a high symmetry.

JP 10-018036 A discloses the use of diethyl-η⁴-(1,5-dimethylcycloocta-1,5-dien)platinum and diethyl-η⁴-(1,6-dimethylcycloocta-1,5-dien)platinum as a precursor for the metal organic chemical vapor deposition method (MOCVD method). The precursors are dissolved in an organic solvent and the solution is used in the MOCVD process. The precursors are used for the formation of thin platinum films which can be used for contacts, wiring, etc. of semiconductor devices.

US 2011/0294672 A1 and WO 2010/081959 A2 disclose the use of platinum precursors with norbornadiene or norbornadiene derivatives being used as a ligand (eg. dimethyl-η⁴-(7-methyl-norbornadiene)platinum or dimethyl-η⁴-norbornadiene platinum). The described precursors are used in a metal organic chemical vapor deposition process (MOCVD process) for the manufacture of a platinum film or dispersion. The films can be used in electronic devices or as catalysts.

WO 03/106734 A2 discloses the use of bis-(perfluoropropyl)-1,5-cyclooctadiene platinum as photosensitive organometallic compounds which are used in the production of metal deposits. Using the described compounds substantially continuous thin ‘sheet-like’ films or substantially narrow lines can be obtained, which possess electrical conductivity.

The possibility of forming a satisfactory metallic deposit via the MOCVD method depends on the volatility of the organometallic (precursor) compound. Specifically, MOCVD requires the possibility of obtaining both a high vapor pressure and high stability of the precursor compound. An organometallic platinum (precursor) compound for use in the MOCVD process
should have a good volatility,
a good thermal stability during its evaporation and transport in the gas phase,
a high purity (or it should be readily purifyable),
it should decompose cleanly on pyrolysis without contamination of the growing film (e.g. by carbon),
it should be non-toxic, non-pyrophoric, not-corrosive
readily available in consistent quality and quantities at low cost, and
it should be stable in its container over a long period.

One particularly interesting application of platinum precursors (organometallic platinum compound) is the preparation of platinum catalysts by metal organic chemical vapor deposition.

Platinum catalysts can be used, for example, in automobiles as catalytic converters, which allow for the complete combustion of remaining low concentrations of unburned hydrocarbons in the exhaust gas mixture into carbon dioxide and water vapor, or other reduction/oxidation reactions. Platinum is also used in the petroleum industry as a catalyst in a number of separate processes, but especially in catalytic reforming of straight run naphthas into higher-octane gasoline.

Triggered by the ever rising prices of platinum several ways were found to increase the activity of platinum catalyst and/or to decrease the amount of platinum used for the production of catalyst. One approach is to deposit a particularly thin platinum film on a substrate. Thus, the ratio between the active platinum surface and the used platinum is improved. This ratio can be improved even further, if small platinum dots instead of a continuous platinum film are deposited on the surface of the substrate.

A primary problem to be solved by the present invention was to provide a platinum precursor for the MOCVD process which allows for the formation of platinum on a surface, especially the formation of platinum dots on a surface, and which shows at the same time one or more of the abovementioned positive properties for MOCVD precursors, especially a good volatility and a good thermal stability during its evaporation and transport in the gas phase. Preferably, the platinum dots on the surface (preferably additionally) exhibit a high dispersion, more preferably in the range of from 20 to 60 percent (see below for more details regarding “dispersion”). Even more preferably the platinum dots on the surface of Al₂O₃ (preferably additionally) exhibit a high dispersion, preferably in the range of from 55 to 60 percent.

### SUMMARY OF THE INVENTION

According to the invention, the primary problem is solved with a compound of the formula (I)

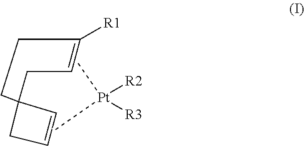

wherein R1 represents a moiety selected from the group consisting of methyl, ethyl, n-propyl, isopropyl, n-butyl, sec-butyl, tert-butyl, linear or branched, saturated or mono- or polyunsaturated aliphatic carbon chain containing from two to ten carbon atoms, phenyl, and phenylacetylen,
and wherein R2 and R3 independently of each other represent a moiety selected from the group consisting of Cl, I, methyl, phenyl, or phenylacetylene.

### DESCRIPTION OF THE DRAWINGS

FIG. 1 is a schematic drawing of an assembly for the continuous generation of particles having platinum dots on their surface in the aerosol state by a combined CVS/MOCVD process under atmospheric pressure.

FIG. 2 is a schematic drawing of an assembly for the continuous generation of particles having platinum dots on their surface in the aerosol state in a MOCVD process under atmospheric pressure.

FIG. 3 is a TEM image of a Pt/SiO₂ particle produced by using a compound of formula (I) according to the invention as a precursor (Example 23).

FIG. 4 is a TEM photograph of a Pt/SiO₂ particle produced using (Trimethyl)methylcylopendadienylplatinum as a precursor (Comparative Example 1).

FIG. 5 shows the result of a thermogravimetric analysis (TGA) of compounds according to the invention in comparison with MeCpPtMe₃ (Example 22).

FIG. 6 is a schematic drawing of an assembly for the generation of particles having platinum dots on their surface in the aerosol state in a MOCVD process under atmospheric pressure.

FIG. 7 is a schematic drawing of an experimental setup for fixed bed MOCVD for the synthesis of supported Pt-nanoparticles.

FIG. 8 shows the median particle size distribution of Pt-nanoparticles on Al₂O₃ synthesized by fixed bed MOCVD.

FIG. 9 shows TEM images of different Pt/metal oxide particles produced by fixed bed MOCVD. FIG. 9A shows Pt-nanoparticles deposited on Al₂O₃, FIG. 9B on TiO₂, and FIG. 9C on SiO₂, respectively.

### DETAILED DESCRIPTION OF THE INVENTION

While not wishing to be bound by any particular theory, it is presently believed that the asymmetry of the compound of the general formula (I), which is the consequence of the monosubstitution of the 1,5-cycloctadien-ligand, the order of the resulting platinum complex in the liquid phase or the crystal is reduced and the volatility of the precursor is increased, compared with symmetric platinum complexes having an otherwise similar structure (e.g. compounds with disubstituted or unsubstituted 1,5-cycloctadien-ligands). Surprisingly, the thermal stability of the compounds of the present invention is still very good.

If in a compound of formula (I) the substituents R2 and R3 are identical the compound of formula (I) is available in consistent quality and quantities at low cost, because the synthesis can be conducted in a particularly effective manner.

Thus, preferably, in the compound according to the invention the substituents R2 and R3 are identical and each represent a group selected from the list consisting of Cl, I, methyl, phenyl, or phenylacetylene.

More preferably, in the compound according to the invention each of the substituents R2 and R3 represents a methyl group.

The compounds of the present invention can be readily evaporated or sublimated at low temperatures, and release the platinum at moderately increased temperature while at the same time the organic ligands of the organometallic compounds rapidly evaporate.

A compound of the present invention is especially preferred which is a compound selected from the group consisting of
dichlorido-η⁴-((1Z,5Z)-1-methylcycloocta-1,5-dien)platinum,
diiodido-η⁴-((1Z,5Z)-1-methylcycloocta-1,5-dien)platinum,
dimethyl-η⁴-((1Z,5Z)-1-methylcycloocta-1,5-dien)platinum,
η⁴-((1Z,5Z)-1-methylcycloocta-1,5-dien)diphenyl platinum,
dichlorido-η⁴-((1Z,5Z)-1-ethylcycloocta-1,5-dien)platinum,
η⁴-((1Z,5Z)-1-ethylcycloocta-1,5-dien)diiodido platinum,
η⁴-((1Z,5Z)-1-ethylcycloocta-1,5-dien)dimethyl platinum,
η⁴-((1Z,5Z)-1-ethylcycloocta-1,5-dien)diphenyl platinum,
dichlorido-η⁴-((1E,5Z)-1-phenylcycloocta-1,5-dien)platinum,
diiodido-η⁴-((1E,5Z)-1-phenylcycloocta-1,5-dien)platinum,
dimethyl-η⁴-((1E,5Z)-1-phenylcycloocta-1,5-dien)platinum,
diphenyl-η⁴-((1E,5Z)-1-phenylcycloocta-1,5-dien)platinum,
dichlorido-η⁴-((1E,5Z)-1-isopropylcycloocta-1,5-dien)platinum,
diiodido-η⁴-((1E,5Z)-1-Isopropylcycloocta-1,5-dien)platinum,
η⁴-((1E,5Z)-1-isopropylcycloocta-1,5-dien)dimethyl platinum,
η⁴-((1Z,5Z)-1-isopropylcycloocta-1,5-dien)diphenyl platinum,
dichlorido-η⁴-((1E,5Z)-1-n-butylcycloocta-1,5-dien)platinum,
diiodido-η⁴-((1E,5Z)-1-n-butylcycloocta-1,5-dien)platinum,
dimethyl-η⁴-((1E,5Z)-1-n-butylcycloocta-1,5-dien)platinum,
diphenyl-η⁴-((1E,5Z)-1-n-butylcycloocta-1,5-dien)platinum,
dichlorido-η⁴-((1E,5Z)-1-iso-butylcycloocta-1,5-dien)platinum,
diiodido-η⁴-((1E,5Z)-1-iso-butylcycloocta-1,5-dien)platinum,
dimethyl-η⁴-((1E,5Z)-1-iso-butylcycloocta-1,5-dien)platinum,
diphenyl-η⁴-((1E,5Z)-1-iso-butylcycloocta-1,5-dien)platinum,
dichlorido-η⁴-((1E,5Z)-1-n-hexylcycloocta-1,5-diene)platinum,
diiodido-η⁴-((1E,5Z)-1-n-hexylcycloocta-1,5-diene)platinum, and η⁴-((1E,5Z)-1-n-hexylcycloocta-1,5-diene)dimethylplatinum
preferably preferred selected from the group consisting of
dimethyl-η⁴-((1E,5Z)-1-n-butylcycloocta-1,5-dien)platinum,
dimethyl-η⁴-((1E,5Z)-1-iso-butylcycloocta-1,5-dien)platinum,
η⁴-((1E,5Z)-1-n-hexylcycloocta-1,5-diene)dimethylplatinum, and
dimethyl-η⁴-((1Z,5Z)-1-ethylcycloocta-1,5-dien)-platinum.

The invention relates also to the use of a compound of the invention (preferably a compound a defined hereinabove as preferred) as a precursor in a metal organic chemical vapor deposition process for depositing platinum onto a substrate. The resulting products (substrates having platinum deposited on their surface) can be used as catalysts, see below for a more detailed discussion.

While not wishing to be bound by any theory, it is believed that a MOCVD process for depositing platinum onto a substrate when using a compound of the present invention consists of the following steps:
Transfer of the precursor (compound of the present invention) into a carrier gas stream, usually by sublimation of the precursor
Transport of the precursor to the substrate
Adsorption of the precursor and/or chemisorption of the precursor on functional groups (e.g. hydroxyl, carbonyl or amino groups) on the surface of the substrate
Cleavage of the volatile ligands from the precursor, and release of platinum from the precursor,
Desorption of the ligands from the surface of the substrate
Structural growth and/or layer growth by surface diffusion of the platinum and/or autocatalysis so that platinum is finally deposited onto the substrate.

It is furthermore believed that during these steps the precursors are adsorbed on the surface of the substrate and interact with oxygen that is also adsorbed on the surface of the substrate. Afterwards the precursor decomposes and releases platinum, gaseous hydrocarbons (e.g. CH₄), CO₂ and water. The formed Pt and Pt—O clusters on the surface of the substrate are already catalytically active and catalyze the decomposition and coating process, leading to the formation of molecular platinum near the cluster.

An abundance of materials may be used as a substrate. In own investigations, it has been shown that some substrate materials have particularly good properties. Thus the use according to the invention is especially preferred where the substrate consists of or comprises (a) one or more oxides selected from the group consisting of SiO₂, MgO, Al₂O₃, TiO₂, ZrO₂, Y₂O₃, Cr₂O₃, La₂O₃, Fe₂O₃, ZnO, and SnO and/or (b) one or more mixed oxides of two, three or more oxides selected from the group consisting of SiO₂, MgO, Al₂O₃, TiO₂, ZrO₂, Y₂O₃, Cr₂O₃, La₂O₃, Fe₂O₃, ZnO, and SnO.

The use of a compound of the present invention as a precursor in a metal organic chemical vapor deposition process for depositing platinum onto a substrate is preferably used for the production of heterogeneous catalysts. Typically, such catalysts have a very high reaction rate if the surface area of the substrate is large, as the platinum is then deposited and distributed on a large (substrate) surface. The smaller the substrate particle size the larger the surface area for a given mass of substrate particles. Thus, the use according to the invention is especially preferred wherein the substrate comprises particles having an average diameter in the range of from 12 to 300 nm as determined by laser diffraction analysis or having an average Feret diameter in the range of from 12 to 300 nm, preferably in the range of from 25 to 200 nm, more preferably in the range of from 40 to 100 nm. For identifying the “Mean Feret diameter” of an individual particle a (two-dimensional) TEM photography is prepared. The Feret diameter (caliper diameter) is the averaged distance between pairs of parallel tangents to the projected outline of the particle. The “Mean Feret diameter” is calculated after consideration of all possible orientations. The Feret diameters for a sufficient number of angles are measured, and their average is calculated.

For identifying the “Average Feret diameter” of a quantity of particles a (two-dimensional) TEM photography of a quantity of particles is prepared. The “Mean Feret diameter” for each individual particle in the TEM photography is determined, and their average is calculated.

The use according to the invention is especially preferred where the substrate is constituted by or comprises a quantity of particles selected from the group consisting of cylindrical, discoidal, tabular, ellipsoidal, equant, irregular, and spherical particles, preferably spherical particles.

Within the present text, in particular particles with a sphericity of more than 0.9 are considered as spherical particles. The “sphericity” is the ratio of the perimeter of the equivalent circle (circle that has the same area as the projection area of the particle) to the real perimeter of the projection of the particle. The result is a value between 0 and 1. The smaller the value, the more irregular is the shape of the particle. This results from the fact that an irregular shape causes an increase of the real perimeter. The ratio is always based on the perimeter of the equivalent circle because this is the smallest possible perimeter with a given projection area. For identifying the sphericity of a particle a (two-dimensional) TEM photography of the particle is prepared.

Surprisingly, our investigations have shown that the precursors according to the invention are particularly well suited for the deposition of platinum dots onto a substrate. The use according to the invention is especially preferred in a metal organic chemical vapor deposition process for depositing one or more platinum dots onto a substrate.

In the context of this text a platinum dot is understood to be a platinum island on the surface of a substrate, the island having a mean Feret diameter of more than 0.1 nm. Accumulations of platinum having a mean Feret diameter of less than 0.1 nm (e.g. isolated platinum atoms on a substrate) are not considered as platinum dots. Platinum dots can be substantially flat (e.g. a monolayer of platinum on the substrate) or can possess a three-dimensional shape, like e.g., a platinum dot having convexity. For identifying the mean Feret diameter of a dot a (two-dimensional) TEM photography is prepared and the mean Feret diameter is determined as described above. For identifying the “Average Feret diameter” of an amount of dots a (two-dimensional) TEM photography of a quantity of dots is prepared. The “Mean Feret diameter” for each individual dot in the TEM photography is determined, and their average is calculated.

Preferred is the use of a compound of the present invention (as defined above, preferably as hereinabove characterized as being preferred) as a precursor in a metal organic chemical vapor deposition process for depositing platinum dots onto a substrate,

wherein the substrate comprises a quantity of particles having an average Feret diameter in the range of from 12 to 300 nm, preferably in the range of from 25 to 200 nm, more preferably in the range of from 40 to 100 nm, and
wherein the substrate consists of or comprises spherical particles consisting of or comprising (a) one or more oxides selected from the group consisting of SiO₂, MgO, Al₂O₃, TiO₂, ZrO₂, Y₂O₃, Cr₂O₃, Na₂O, La₂O₃, Fe₂O₃, ZnO, and SnO and/or (b) one or more mixed oxides of two, three or more oxides selected from the group consisting of SiO₂, MgO, Al₂O₃, TiO₂, ZrO₂, Y₂O₃, Cr₂O₃, Na₂O, La₂O₃, Fe₂O₃, ZnO, and SnO.

Also preferred is the use of a compound according to the present invention (as defined above) as a precursor in a metal organic chemical vapor deposition process for depositing platinum dots onto a substrate,

wherein the substrate comprises a quantity of particles having an average Feret diameter in the range of from 10 to 300 nm, and
wherein the substrate consists of spherical particles consisting of (a) one or more oxides selected from the group consisting of SiO₂, Al₂O₃, TiO₂, Fe₂O₃, ZnO, and SnO and/or (b) one or more mixed oxides of two, three or more oxides selected from the group consisting of SiO₂, Al₂O₃, TiO₂, Fe₂O₃, ZnO, and SnO.

Surprisingly, our own investigations have shown that in the use according to the invention platinum dots can be deposited having a narrow size distribution and a small dot diameter. The use according to the invention is preferred where at least some of the platinum dots deposited on the substrate have a mean Feret diameter below 10 nm, preferably in the range of from 0.5 to 8 nm, more preferably in the range of from 1 to 4 nm.

Preferred is the use of a compound according to the present invention (as defined above, preferably as hereinabove characterized as being preferred) as a precursor in a metal organic chemical vapor deposition process for depositing platinum dots onto a substrate,

wherein the substrate consists of spherical particles consisting of (a) one or more oxides selected from the group consisting of SiO₂, Al₂O₃, TiO₂, Fe₂O₃, ZnO, and SnO and/or (b) one or more mixed oxides of two, three or more oxides selected from the group consisting of SiO₂, Al₂O₃, TiO₂, Fe₂O₃, ZnO, and SnO,
wherein at least some of the platinum dot(s) deposited on the substrate have a mean Feret diameter below 10 nm, preferably in the range of from 0.5 to 8 nm, more preferably in the range of from 1 to 4 nm, and
wherein preferably the substrate comprises a quantity of particles having an average Feret diameter in the range of from 10 to 300 nm.

The use according to the invention is especially preferred where at least 90% of those platinum dots having a minimum mean Feret diameter of 1 nm have a mean Feret diameter in the range of from 1 to 4 nm.

The use according to the invention is especially preferred, wherein at least 90% of the platinum dots have a mean Feret diameter in the range of from 70% to 130%, preferably 80% to 120%, more preferably 90% to 110%, of the average Feret diameter of the platinum dots.

Due to the high volatility and high stability of the compound of the present invention it is possible to use these compounds in MOCVD processes performed under atmospheric pressure. The use according to the invention is especially preferred where the metal organic chemical vapor deposition process is at least partly or completely performed under a pressure in the range of from 1 mbar to 2000 mbar, preferably in the range of from 500 mbar to 1500 mbar, more preferably in the range of from 900 mbar to 1200 mbar.

The use according to the invention is especially preferred where the MOCVD process is performed in a continuous gas-phase or in a fluidized bed.

The invention also relates to a method for depositing platinum onto a substrate comprising the following step:
contacting a compound of formula (I) according to the present invention with a substrate under conditions in which the compound of formula (I) decomposes into metallic platinum.

The method of the present invention is closely related to the use of the present invention. Thus, preferred embodiments of the use of the invention as discussed above correspond to preferred embodiments of the method of the present invention. The products of the method of the present invention (substrates having platinum deposited on their surface) can be used as catalysts, see below for a more detailed discussion.

Thus, a method of the present invention is preferred wherein the substrate consists of or comprises (a) one or more oxides selected from the group consisting of SiO₂, MgO, Al₂O₃, TiO₂, ZrO₂, Y₂O₃, Cr₂O₃, La₂O₃, Fe₂O₃, ZnO, and SnO and/or (b) one or more mixed oxides of two, three or more oxides selected from the group consisting of SiO₂, MgO, Al₂O₃, TiO₂, ZrO₂, Y₂O₃, Cr₂O₃, La₂O₃, Fe₂O₃, ZnO, and SnO.

Furthermore, a method of the present invention is preferred wherein the substrate comprises a quantity of particles having an average Feret diameter in the range of from 12 to 300 nm, preferably in the range of from 25 to 200 nm, more preferably in the range of from 40 to 100 nm.

Even further, a method of the present invention is preferred wherein the substrate comprises a quantity of particles selected from the group consisting of cylindrical, discoidal, tabular, ellipsoidal, equant, irregular, and spherical particles, preferably spherical particles. See above for further discussions and definitions.

A method of the present invention is preferred wherein contacting the compound of formula (I) of the present invention with a substrate is performed during a metal organic chemical vapor deposition process so that platinum dots are prepared on the surface of the substrate. I.e., the compound of formula (I) of the present invention is contacted with the substrate so that platinum dots (rather than a continuous platinum film) are prepared on the surface of the substrate.

A method of the present invention is especially preferred, wherein at least some of the platinum dots deposited on the substrate have a mean Feret diameter below 10 nm, preferably in the range of from 0.5 to 8 nm, more preferably in the range of from 1 to 4 nm.

A method of the present invention is especially preferred, wherein at least 90% of the platinum dots deposited on the substrate have a mean Feret diameter in the range of from 70% to 130%, preferably 80% to 120%, more preferably 90% to 110%, of the average Feret diameter of the platinum dots.

A method of the present invention is especially preferred wherein the method is at least partly or completely performed under a pressure in the range of from 1 mbar to 2000 mbar, preferably in the range of from 500 mbar to 1500 mbar, more preferably in the range of from 900 mbar to 1200 mbar.

Features of preferred embodiments of the method of the present invention are preferably combined to particularly preferred embodiments.

Particularly preferred is a method of the present invention (as defined above, preferably as hereinabove characterized as being preferred)

wherein contacting the compound of formula (I) according to the invention with the substrate is performed during a metal organic chemical vapor deposition process so that platinum dots are prepared on the surface of the substrate,
wherein at least some of the platinum dots deposited on the substrate have a mean Feret diameter in the range of from 1 to 4 nm,
wherein the method is at least partly or completely performed under a pressure in the range of from 900 mbar to 1200 mbar.

Very preferred is a method according to the present invention (as defined above, preferably as hereinabove characterized as being preferred)

wherein contacting the compound of formula (I) according to the invention with the substrate is performed during a metal organic chemical vapor deposition process so that platinum dots are prepared on the surface of the substrate,
wherein at least some of the platinum dots deposited on the substrate have a mean Feret diameter in the range of from 1 to 4 nm,
wherein the substrate consists of or comprises (a) one or more oxides selected from the group consisting of SiO₂, MgO, Al₂O₃, TiO₂, ZrO₂, Y₂O₃, Cr₂O₃, La₂O₃, Fe₂O₃, ZnO, and SnO and/or (b) one or more mixed oxides of two, three or more oxides selected from the group consisting of SiO₂, MgO, Al₂O₃, TiO₂, ZrO₂, Y₂O₃, Cr₂O₃, La₂O₃, Fe₂O₃, ZnO, and SnO,
wherein the substrate comprises a quantity of spherical particles having an average Feret diameter in the range of from 40 to 100 nm, and
wherein the method is at least partly or completely performed under a pressure in the range of from 900 mbar to 1200 mbar.

The invention also relates to a product comprising or consisting of a quantity of particles (of substrate material) having platinum dots on their surface,

wherein the particles having platinum dots on their surface, without consideration of the platinum dots, have an average Feret diameter in the range of from 12 to 300 nm, preferably in the range of from 25 to 200 nm, more preferably in the range of from 40 to 100 nm, and
wherein the platinum dots have a mean Feret diameter below 10 nm, preferably in the range of from 0.5 to 8 nm, more preferably in the range of from 1 to 4 nm.

The respective Feret diameter of the substrate (average Feret diameter) and the platinum dots (mean Feret diameter) are determined as described above. The product of the present invention (amount of particles having platinum dots on their surface) can be used as a catalyst or as catalytically active component of catalyst system. The product is characterized by a high activity corresponding to a large platinum surface area achieved with a low mass of platinum deposited (i.e. the ratio of platinum surface area to platinum mass deposited is particularly favorable).

A product according to the invention, wherein at least 90% of those platinum dots having a minimum mean Feret diameter of 1 nm have a mean Feret diameter in the range of from 1 to 4 nm, is further preferred. Surprisingly, when using (preferred) compounds of the present invention in a method of the present invention method parameters can readily be identified resulting in such narrow platinum dot diameter distribution.

A product according to the invention is preferred, wherein the particles have at least 1 dot per 100 nm², preferably at least 4 dots per 100 nm², more preferably at least 6 dots per 100 nm² of the particle surface.

For identifying the number of dots per 100 nm² a (two-dimensional) TEM photography of an individual particle is prepared and the particles in an area of 100 nm² are counted.

An abundance of materials may be used as a substrate of the product. In our investigations, it has been shown that products with some substrate materials have particularly good properties. Thus products of the invention are especially preferred wherein the substrate consists of or comprises (a) one or more oxides selected from the group consisting of SiO₂, MgO, Al₂O₃, TiO₂, ZrO₂, Y₂O₃, Cr₂O₃, La₂O₃, Fe₂O₃, ZnO, and SnO and/or (b) one or more mixed oxides of two, three or more oxides selected from the group consisting of SiO₂, MgO, Al₂O₃, TiO₂, ZrO₂, Y₂O₃, Cr₂O₃, La₂O₃, Fe₂O₃, ZnO, and SnO.

Furthermore, a product according to the invention is preferred, wherein the substrate having one or more platinum dots on its surface is obtainable by a metal organic chemical vapor deposition process using the substrate not having dots as the substrate in the MOCVD process.

These products are characterized by the fact that the platinum dots have a narrow size distribution and have fewer impurities than products produced by wet chemical processes.

A product according to the invention is particularly preferred, wherein at least 90% of the platinum dots have a mean Feret diameter in the range of from 70% to 130%, preferably 80% to 120%, more preferably 90% to 110%, of the average Feret diameter of the platinum dots.

Products of the present invention are preferably prepared by or preparable by a method of the present invention as discussed above. When corresponding products of the invention are carefully analyzed traces of compounds of formula (I) can be detected so that products prepared by a method of the present invention can be distinguished from other products.

A product according to the invention is particularly preferred, wherein the substrate having one or more platinum dots on its surface is obtainable by a metal organic chemical vapor deposition process, wherein a compound of the present invention is used as precursor to form the platinum dot(s) and/or the metal organic chemical vapor deposition process is performed according to the method as described above.

The invention also relates to the use of a product of the present invention (as defined above) as a catalyst (heterogeneous catalyst or photocatalyst), as part of an optical sensor, or as part of a gas sensor.

The present invention also relates to a catalyst system, preferably a catalyst system in a catalytic converter or for asymmetric hydrogenation, comprising or consisting of a product according to the invention.

Within the present text, a catalyst system is considered to be a functional unit consisting of or comprising the catalyst. E.g., the supporting material or the casing of the catalyst in a catalytic converter are considered to be a part of a catalyst system.

The present invention also relates to a use of a product according to the invention as a catalyst, preferably in a catalytic converter or for the asymmetric hydrogenation.

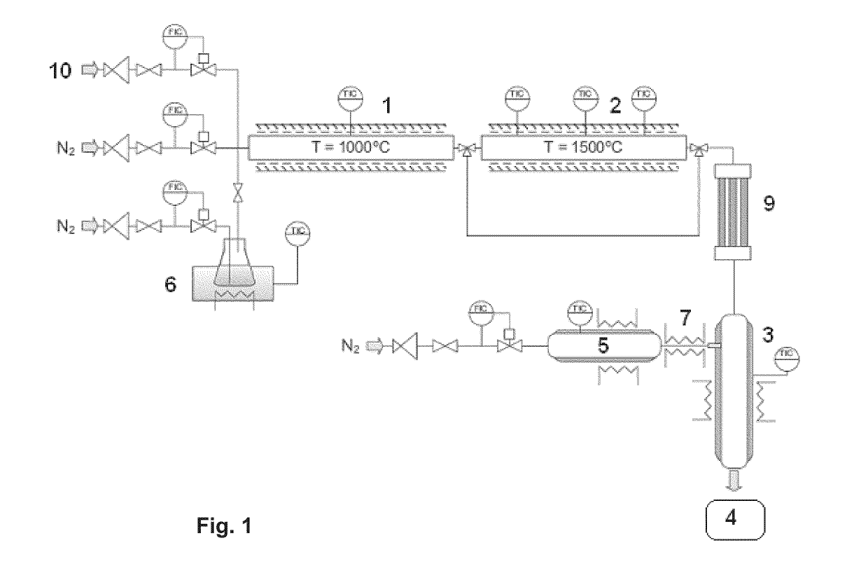

The system shown in FIG. 1 consists of a CVS reactor (1) for the production of particles by CVS (chemical vapor synthesis), a sintering furnace (2) for the sintering of the produced particles, and a diffusion dryer (9) in which water can be removed from a particle aerosol produced in the CVS reactor (1) and sintered in the sintering furnace (2).

A nitrogen (N₂) stream that is saturated in a bubbling system (6) with a precursor for the CVS, air (10) and additional nitrogen (N₂) can be introduced into the CVS reactor (1), and the synthezised product can be transported into the sintering furnace (2), and subsequently into diffusion dryer (9).

The assembly depicted in FIG. 1 furthermore comprises a precursor sublimator (5), a heated transfer pipe (7), and a coating reactor (3).

The metal organic precursor for MOCVD can be vaporized in the precursor sublimator (5) into a flow of nitrogen (N₂) provided by a nitrogen source. The vaporized metal organic precursor is subsequently transferred through a heated transfer pipe (7) to the coating reactor (3). In the reactor the particle aerosol that was dried in the diffusion dryer (9) and the vaporized metal organic precursor are mixed, the precursor releases platinum and platinum deposition on the substrate (i.e. the particles of the aerosol) takes place. The resulting particles (4) having platinum dots on their surface can be collected on a membrane, a TEM grid or can be analyzed via online measuring methods after leaving the coating reactor (3). The temperatures of the CVS reactor (1), sintering furnace (2), diffusion dryer (9), bubbling system (6), precursor sublimate (5) and the precursor sublimate (5) are controlled with Temperature Indicator Controllers (TIC). The flow of the Nitrogen (N₂) and the air (10) is controlled with Flow Indicator Controllers (FIC).

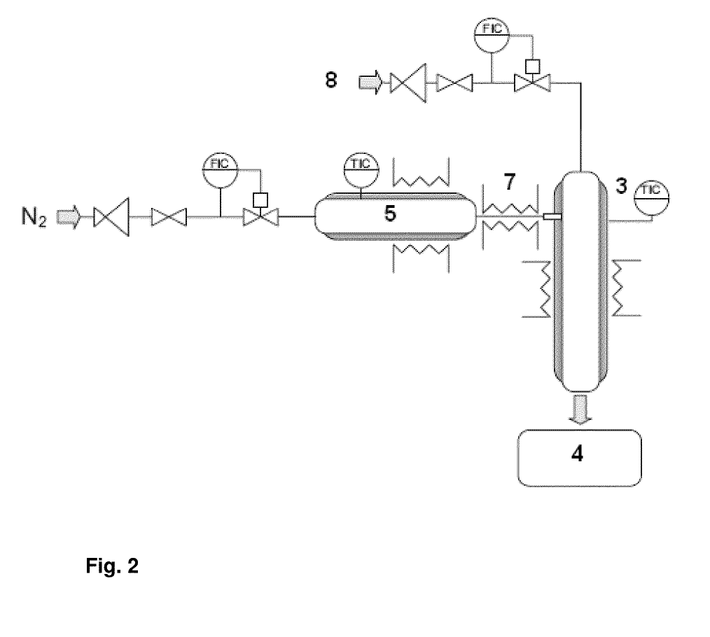

The assembly depicted in FIG. 2 comprises a precursor sublimator (5), a heated transfer pipe (7), and a coating reactor (3).

The metal organic precursor for MOCVD can be vaporized in the precursor sublimator (5) into a flow of nitrogen (N₂) provided by a nitrogen source. The vaporized metal organic precursor is subsequently transferred through a heated transfer pipe (7) to the coating reactor (3). In the reactor a particle aerosol (8) containing the particles that are deposited and the precursor vapor are mixed, the precursor releases platinum and platinum deposition on the substrate (i.e. the particles of the aerosol) takes place. The resulting particles (4) having platinum dots on their surface can be collected on a membrane, a TEM grid or can be analyzed via online measuring methods after leaving the coating reactor (3). The temperatures of the CVS reactor (1), sintering furnace (2), diffusion dryer (9), bubbling system (6), precursor sublimate (5) and the precursor sublimate (5) are controlled with Temperature Indicator Controllers (TIC). The flow of the Nitrogen (N₂) and the air (10) is controlled with Flow Indicator Controllers (FIC).

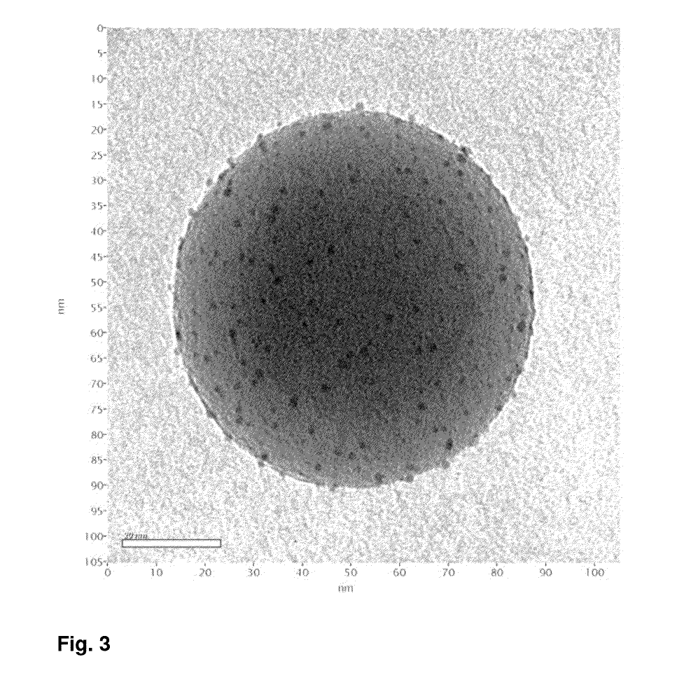

A TEM image of a Pt/SiO₂ particle produced by using a compound of formula (I) as a precursor (Example 23) is shown in FIG. 3. For the TEM image analysis Pt/SiO2 particles were generated and then collected on a TEM grid. Images were made using a Philips CM12. The image analyses were made using the imaging software “Image C” (Soft Imaging System).

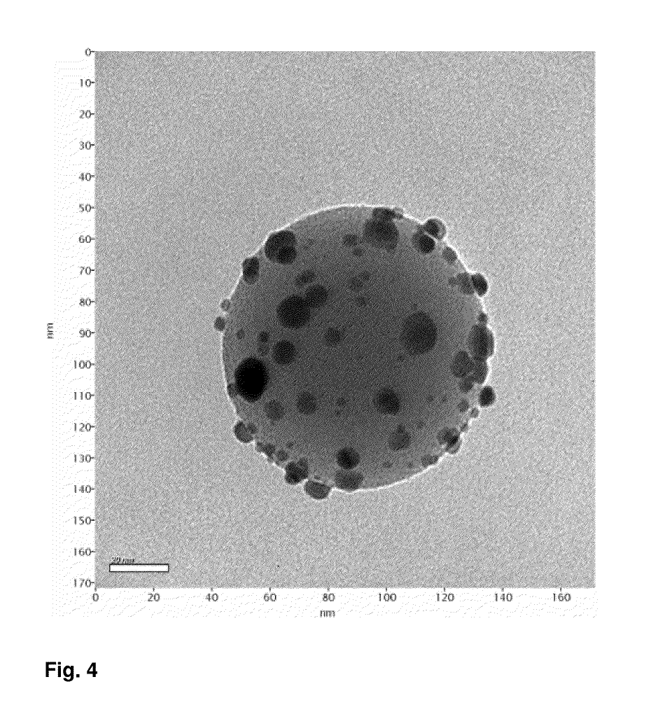

A TEM image of a Pt/SiO₂ particle produced by using (Trimethyl)methylcylopendadienylplatinum as a precursor (Comparative Example 1) is shown in FIG. 4. For the TEM image analysis Pt/SiO₂ particles were generated and then collected on a TEM grid. Images were made using a Philips CM12. The image analyses were made using the imaging software “Image C” (Soft Imaging System)

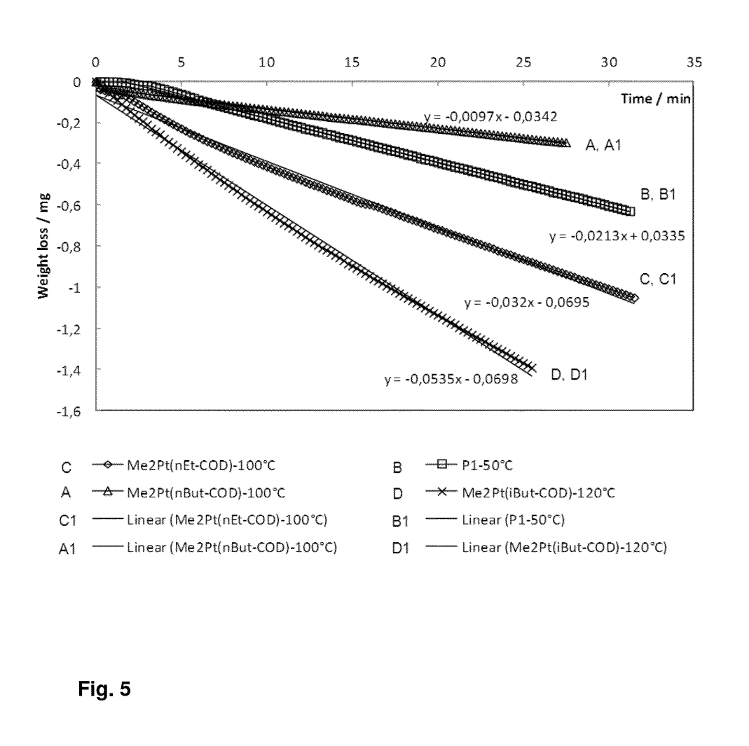

FIG. 5 shows the result of a thermogravimetric analysis (TGA) of compounds according to the invention in comparison with MeCpPtMe₃ (Example 22).

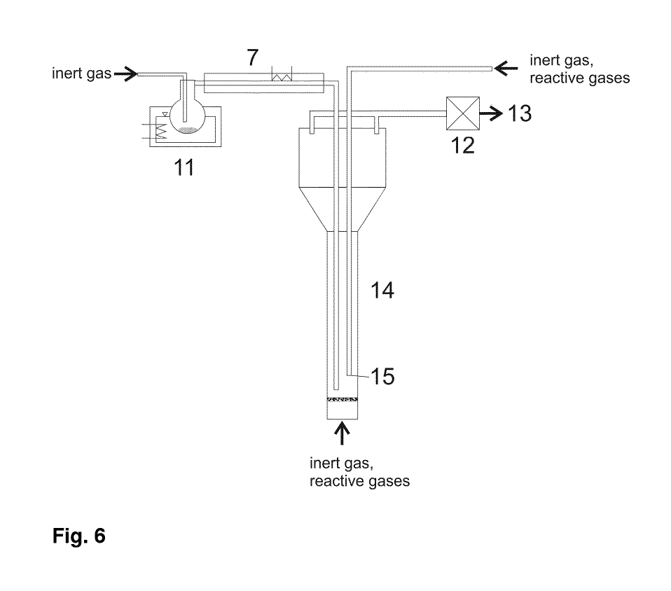

The assembly depicted in FIG. 6 comprises a precursor sublimator (11), a fluidized bed reactor (14), a heated transfer pipe (7), and a filter (12).

The metal organic precursor for MOCVD can be vaporized in the precursor sublimator (11) into a flow of an inert gas (e.g. N₂) provided by a inert gas source. The vaporized metal organic precursor is subsequently transferred through a heated transfer pipe (7) to a fluidized bed reactor (14). The fluidized bed reactor (14) contains substrate particles and inert gas reactive gas mixture (e.g. N₂/O₂) is passed through the particle bed to suspend the particles.

In the fluidized bed reactor (14) the substrate particles and the precursor vapor are mixed, the precursor releases platinum and platinum deposition on the substrate (i.e. the particles of the aerosol) takes place. To avoid any loss of particles the exhaust gases (13) pass a filter (12).

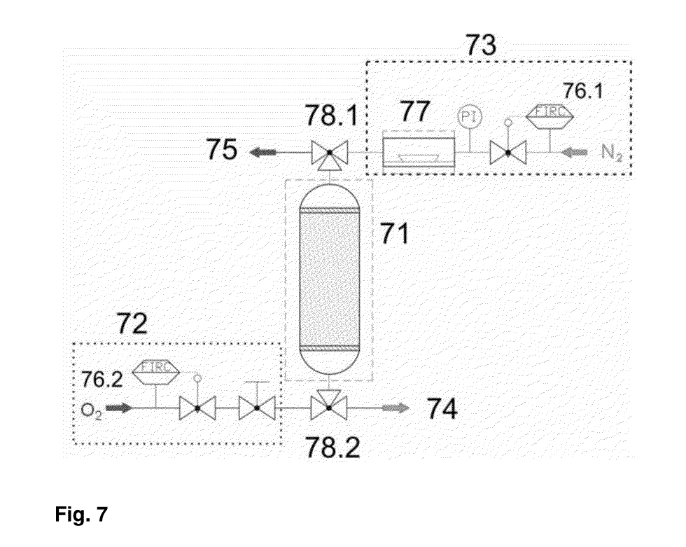

The experimental setup for fixed bed MOCVD for the synthesis of supported Pt-nanoparticles shown in FIG. 7 comprises a CVD reactor (71) for the production of Pt-nanoparticles and means for O₂ delivery (72), means for precursor delivery (73), means for precursor exhaust (74), and means for oxidation exhaust (75). In addition, the system includes a first mass flow controller (76.1), a second mass flow controller (76.2), a precursor evaporator (77), a top three-way valve (78.1), and a bottom three-way valve (78.2).

All gas streams were controlled by mass flow controllers (76.1 and 76.2). The precursor evaporator (77) was isothermally heated by an oil-bath ensuring continuous and homogeneous precursor delivery. A self-built stainless steel reactor (71) was constructed and fitted inside an experimental setup. The reactor consisted of two stainless steel frits (Macherey and Nagel) with a porosity of 0.5 micrometer at each end of a stainless steel tube, fixed inside a tube furnace. Two thermally isolated three-way valves (on the top (78.1) and on the bottom (78.2) of the reactor) were used in order to switch between precursor delivery under flowing nitrogen or oxidation, ensuring good gas supply and removal. This means that the reactor operates in either of two active modes: (i) the three-way valves 78.1 and 78.2 are opened such that precursors under nitrogen gas flow are delivered and precursor exhausts are released and (ii) the three-way valves 78.1 and 78.2 are opened such that oxygen for oxidation is delivered and oxidation exhausts are released.

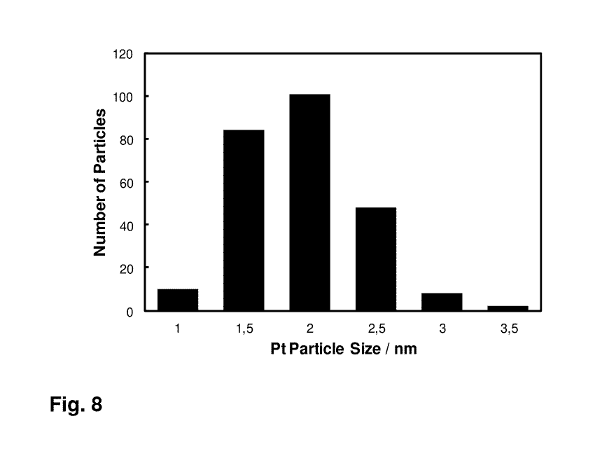

The median particle size distribution of Pt-nanoparticles on Al₂O₃ synthesized by fixed bed MOCVD is shown in FIG. 8.

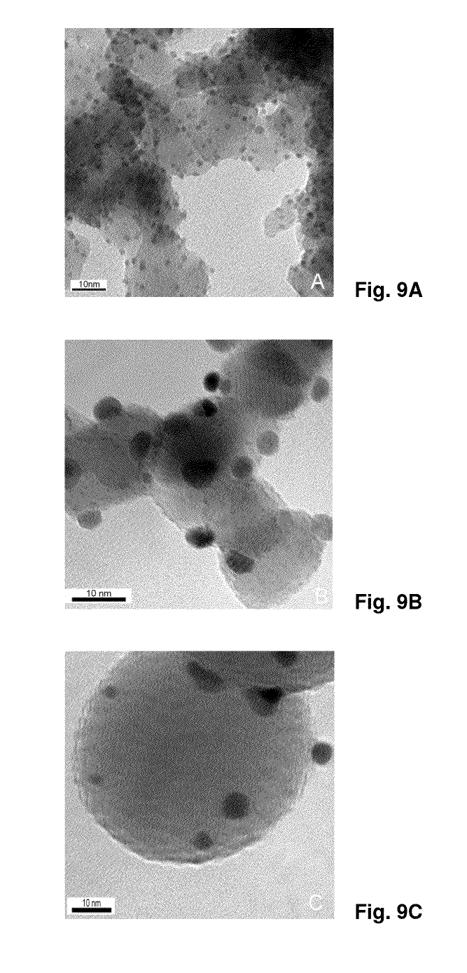

FIG. 9 presents TEM images of different Pt/metal oxide particles produced by fixed bed MOCVD. FIG. 9A shows Pt-nanoparticles deposited on Al₂O₃, FIG. 9B on TiO₂, and FIG. 9C on SiO₂, respectively. For the TEM image analysis, respective Pt/metal oxide particles were generated and then collected on a TEM grid. Images were made using a Philips CM12. The image analyses were made using the imaging software “Image C” (Soft Imaging System).

The invention is now further described by selected examples and embodiments. These embodiments and examples are intended to represent certain preferred features of the present invention, without limiting the scope of this description or the scope of the claims. It is to be understood that the skilled artisan can devise further working examples and embodiments by his common general knowledge and the instructions and explanations given in this description and the documents incorporated herein by reference.

### EXAMPLES

### Example 1

### General Procedure for the Synthesis of Platinum Complexes of the Type [PtCl₂(1-R-1,5-COD)]

n-Propanol and the monosubstituted 1,5-Cycloocatdiene (6.90 eq.) are added to a solution of K₂PtCl₄ (1.00 eq.) in water. Afterwards SnCl₂ (0.0300 eq.) is added and the mixture is stirred for two to five days at room temperature. The initial dark red to brownish solution becomes nearly colorless and the formation of a precipitate can be observed. The resulting precipitate is filtered, washed twice with water and once with ethanol or pentane and dried under reduced pressure.

### Example 2

### General Procedure for the Synthesis of Platinum Complexes of the Type [PtI₂(1-R-1,5-COD)]

NaI (2.15 eq.) is added at room temperature to a suspension of PtCl₂(1-R-1,5-COD)] (1.00 eq.; synthesized as described in Example 1) in acetone. The color of the reaction mixture initially turns yellow and the mixture is stirred for three hours. Afterwards the acetone is removed under reduced pressure and the resulting residue is dissolved in a mixture of dichloromethane and water (1:1). The phases are separated and the organic phase is washed twice with water, dried over sodium sulfate and filtered. After removal of the solvent under reduced pressure, the desired PtI₂(1-R-1,5-COD) complex can be obtained as a bright yellow to orange solid or wax.

### Example 3

### General Procedure for the Synthesis of Platinum Complexes of the Type [PtMe₂(1-R-1,5-COD)]

A solution of MeLi in pentane (1.6 M, 3.00 eq.) is added dropwise at 0° C. to a suspension of [PtI₂(1-R-1,5-COD)] (1.00 eq.; synthesized as described in Example 2) and dry diethyl ether. The color of the reaction mixture turns brown during the reaction. After two hours an ice-cold ammonium chloride solution is added. The aqueous phase is extracted three times with diethyl ether and the organic phases are collected, dried over sodium sulfate, filtered and the solvent is removed under reduced pressure. The crude product may be slightly yellow and can be purified by column chromatography over silica gel (cyclohexane, 2% triethylamine).

### Example 4

### General Procedure for the Synthesis of Platinum Complexes of the Type [PtPh₂(1-R-1,5-COD)]

PtCl₂(1-R-1,5-COD)] (1.00 eq.; synthesized as described in Example 1) is dissolved in dry diethyl ether. Phenylmagnesium bromide (2 M in tetrahydrofuran, 2.20 eq.) is added dropwise to the mixture. The resulting reaction mixture was stirred for 12 hours at room temperature and treated afterwards with an ammonium chloride solution. The aqueous phase is extracted three times with diethyl ether, the organic phases are collected, dried over sodium sulfate, filtered through Celite and activated carbon and the solvent is removed under reduced pressure. The resulting colorless solid is recrystallized from dichloromethane and pentane.

### Example 5

### General Procedure for the Synthesis of Platinum Complexes of the Type [PtMe₂(1-R-1,5-COD)]

Pt(acac)₂ (1.00 eq.) and the monosubstituted 1,5-Cycloocatdiene (1.10 eq.) are dissolved in dry toluene. Trimethylaluminium (2.0 M in Toluol, 3.00 eq.) is added dropwise to the solution and the resulting reaction mixture was stirred 24 hours at room temperature. Afterwards the reaction mixture is quenched with an ammonium chloride solution and the organic phase is separated and washed several times with an aqueous 1 M hydrochloric acid solution and a sodium chloride solution. The separated organic phase is dried over sodium sulfate, filtered and the solvent is removed under reduced pressure. The crude product may be slightly yellow and can be purified by column chromatography over silica gel (cyclohexane, 2% triethylamine).

### Example 6

### Dichlorido-η⁴-((1Z,5Z)-1-methylcycloocta-1,5-diene)-platinum [PtCl₂(Me-COD)]

The compound was prepared according to the general procedure for the synthesis of platinum complexes of example 1. 1.01 g (6.90 eq., 8.26 mmol) (1Z,5Z)-1-methylcycloocta-1,5-diene was stirred with 497 mg (1.00 eq., 1.20 mmol) K₂PtCl₄, 5.77 mL n-PrOH, 8.42 mL H₂O and 7.00 mg (0.0300 eq., 36.0 μmol) SnCl₂ for two days. 323 mg (0.832 mmol, 70%) of the desired product could be obtained as beige solid.—Decomposition temperature: 213° C.—¹H-NMR (400 MHz, CDCl₃): δ (ppm)=1.95 (s d, ²J_{PtH}=17.9 Hz, 3H, CH₃), 2.03-2.09 (m, 1H, CH₂), 2.15-2.50 (m, 4H, CH₂), 2.55-2.68 (m, 1H, CH₂), 2.70-2.90 (m, 2H, CH₂), 5.35-5.55 (dd, ³J_{HH}=6.9 Hz, ⁴J_{HH}=2.8 Hz, 1H, CH), 5.55-5.75 (m, 2H, CH).—¹³C-NMR (100 MHz, CDCl₃): δ (ppm)=29.0 (+, CH₃), 29.4 (−, CH₂), 30.7 (−, CH₂), 31.7 (−, CH₂), 38.0 (−, CH₂), 96.1 (+, CH), 97.7 (+, CH), 99.9 (+, CH), 124.0 (C_{quart}).—¹⁹⁵Pt-NMR (129 MHz, CDCl₃): δ (ppm)=3298 (s).—IR (ATR) [cm⁻¹]: v⁻¹=3007 (vw), 2931 (vw), 2879 (vw), 2076 (vw), 1653 (vw), 1511 (vw), 1478 (vw), 1458 (vw), 1430 (w), 1372 (vw), 1348 (vw), 1334 (vw), 1312 (w), 1240 (vw), 1212 (vw), 1172 (vw), 1099 (vw), 1061 (vw), 1039 (vw), 1025 (vw), 1008 (w), 969 (vw), 903 (vw), 874 (vw), 854 (vw), 832 (vw), 798 (w).—UV/Vis (CHCl₃): λₘₐₓ (log ∈)=229 (0.71), 250 (0.84), 299 (0.19), 386 (0.07) nm.—MS (70 eV, El), m/z (%): 390/389/388/387/386 (10/9/17/13/11) [M⁺], 355/354/353/352/351/350 (9/39/36/100/86/74) [M⁺−Cl], 318/317/316/315/314/313/312/311/310/309/308 (13/23/76/84/86/55/60/36/38/28/13) [M⁺-2×Cl], 286/285/284/283 (14/23/23/13), 273/272/271 (11/12/9), 261/260/259 (10/10/8), 235/234 (9/9), 122 (10) [C₉H₁₄⁺], 107 (13) [C₈H₁₁⁺].—HRMS (PtCl₂C₉H₁₄): calc. 387.0121; found 387.0124.—EA (PtCl₂C₉H₁₄): calc. C, 27.85; H, 3.64; found C, 27.91; H, 3.60.

### Example 7

### Diiodido-η⁴-((1Z,5Z)-1-methylcycloocta-1,5-dien)-platinum [PtI₂(Me-COD)]

The compound was prepared according to the general procedure for the synthesis of platinum complexes of example 2. 50.0 mg (1.00 eq., 0.128 mmol) [PtCl₂(Me-COD)] and 43.2 mg (2.15 eq., 0.258 mmol) NaI in 3 mL acetone were stirred together for three hours. 71.1 mg (0.126 mmol, 97%) of the desired product could be obtained as yellow solid.—Decomposition temperature: >170° C.—¹H-NMR (400 MHz, CDCl₃): δ (ppm)=1.70-1.90 (m, 1H, CH₂), 1.90-2.20 (m, 3H, CH₂), 2.08 (s d, ²J_{PtH}=20.7 Hz, 3H, CH₃), 2.20-2.40 (m, 2H, CH₂), 2.50-2.61 (m, 1H, CH₂), 2.61-2.80 (m, 1H, CH₂), 5.56-6.02 (m, 3H, CH).—¹³C-NMR (100 MHz, CDCl₃): δ (ppm)=29.8 (−, CH₂), 31.9 (−, CH₂), 32.3 (+, CH₃), 32.5 (−, CH₂), 36.2 (−, CH₂), 99.5 (+, CH), 99.7 (+, CH), 101.1 (+, CH), 128.9 (C_{quart}).—¹⁹⁵Pt-NMR (129 MHz, CDCl₃): δ (ppm)=−4240 (s).—IR (ATR) [cm⁻¹]: v⁻¹=3000 (vw), 2940 (vw), 2874 (vw), 2825 (vw), 2108 (vw), 1718 (vw), 1511 (vw), 1492 (vw), 1477 (vw), 1423 (w), 1368 (vw), 1347 (vw), 1335 (vw), 1312 (w), 1237 (vw), 1210 (vw), 1191 (vw), 1169 (vw), 1142 (vw), 1095 (w), 1061 (vw), 1036 (vw), 1022 (vw), 1006 (w), 967 (vw), 939 (vw), 895 (vw), 874 (w), 853 (vw).—MS (70 eV, El), m/z (%): 574/572/571/570 (10/45/60/50) [M⁺], 445/444/443/442/441 (25/30/36/11/15) [M⁺−I], 316/315/314/313/312/311/310 (11/18/12/18/12/17/12) (13/23/76/84/86/55/60/36/38/28/13) [M⁺−2×I], 122 (52) [C₉H₁₄⁺], 107 (39) [C₈H₁₁⁺], 94 (41), 68 (100).—HRMS (PtI₂C₉H₁₄): calc. 570.8833; found 570.8831.—EA (PtI₂C₉H₁₄): calc. C, 18.93; H, 2.47; found C, 19.70, H, 2.58.

### Example 8

### Dimethyl-η⁴-((1Z,5Z)-1-methylcycloocta-1,5-dien)platinum [PtMe₂(Me-COD)]

The compound was prepared according to the general procedure for the synthesis of platinum complexes of example 5. 100 mg (1.00 eq., 0.254 mmol) Pt(acac)₂ and 34.2 mg (1.10 eq., 0.254 mmol) (1Z,5Z)-1-methylcycloocta-1,5-diene were dissolved in 10 mL toluene and 0.381 mL (2.0 M in toluene, 3.00 eq., 0.762 mmol) AlMe₃ was added dropwise. The crude product was purified by column chromatography over silica gel (cyclohexane, 2% triethylamine). 60.0 mg (0.172 mmol, 68%) of the desired product could be obtained as slightly yellow solid.—Melting point: 58° C.—¹H-NMR (400 MHz, CDCl₃): δ (ppm)=0.71 (s d, ²J_{PtH}=81.4 Hz, 6H, CH₃), 1.79 (s d, ²J_{PtH}=21.2 Hz, 3H, CH₃), 2.10-2.50 (m, 8H, CH₂), 4.56-4.88 (m, 3H, CH).—¹³C-NMR (100 MHz, CDCl₃): δ (ppm)=2.9 (+, s d, ¹J_{Ptc}=762 Hz, PtCH₃), 9.9 (+, s d, ¹J_{Ptc}=796 Hz, PtCH₃), 26.7 (−, CH₂), 26.9 (−, CH₂), 29.2 (−, CH₂), 30.2 (−, CH₂), 37.0 (+, CH₃), 97.7 (+, s d, ¹J_{Ptc}=54.0 Hz, CH), 98.4 (+, s d, ¹J_{Ptc}=60.0 Hz, CH), 98.9 (+, s d, ¹J_{Ptc}=44.6 Hz, CH), 115.4 (C_{quart}).—¹⁹⁵Pt-NMR (129 MHz, CDCl₃): δ (ppm)=−3521 (s).—IR (ATR) [cm⁻¹]: v⁻¹=2992 (vw), 2917 (w), 2864 (m), 2793 (vw), 1524 (vw), 1478 (w), 1425 (w), 1371 (vw), 1345 (vw), 1314 (w), 1260 (vw), 1239 (vw), 1213 (vw), 1193 (w), 1170 (vw), 1144 (vw), 1098 (vw), 1025 (m), 989 (w), 961 (w), 899 (vw), 855 (w), 806 (vw), 786 (m), 734 (vw), 601 (vw), 555 (vw), 540 (m), 459 (w).—MS (70 eV, El), m/z (%): 350/349/348/347/346 (4/1/16/20/18) [M⁺], 335/334/333/332/331 (1/1/6/8/7) [M⁺−CH₃], 320/319/318/317/316/315/314/313/312/311 (5/17/23/83/100/82/20/23/13/13) [M⁺−2×CH₃].—HRMS: (PtC₁₁H₂₀): calc. 347.1213; found. 347.1215.

### Example 9

### η⁴-((1Z,5Z)-1-Methylcycloocta-1,5-diene)diphenyl platinum [PtPh₂(Me-COD)]

The compound was prepared according to the general procedure for the synthesis of platinum complexes of example 4. 50.0 mg (1.00 eq., 0.128 mmol) [PtCl₂(Me-COD)] were reacted with 150 μL (2 M in tetrahydrofuran, 2.20 eq., 0.281 mmol) PhMgCl. The resulting crude product is recrystallized from dichloromethane and pentane. 55.1 mg (0.115 mmol, 90%) of the desired product could be obtained as colorless solid.—Decomposition temperature: >110° C.—¹H-NMR (400 MHz, CDCl₃): δ=1.45 (s d, ²J_{PtH}=23.6 Hz, 3H, CH₃), 2.22-2.69 (m, 8H, CH₂), 4.72-5.18 (m, 3H, CH), 6.77 (t, ³J=7.3 Hz, 2H, C_{Ar}H), 6.96 (t, ³J=7.3 Hz, 4H, C_{Ar}H), 7.00-7.20 (m, 1H, C_{Ar}H), 7.22 (t, ³J=7.3 Hz, 2H, C_{Ar}H).—¹³C-NMR (100 MHz, CDCl₃): δ=28.1 (+, CH₃), 29.3 (−, CH₂), 29.5 (−, CH₂), 29.9 (−, CH₂), 36.7 (−, CH₂), 103.7 (+, CH), 103.9 (+, CH), 104.6 (+, CH), 115.2 (C_{quart.}), 121.3 (C_{quart.}), 127.2 (+, 2×C_{Ar}), 127.5 (+, 2×C_{Ar}), 128.7 (+, 2×C_{Ar}), 134.5 (+, 2×C_{Ar}), 134.8 (+, 2×C_{Ar}).—¹⁹⁵Pt-NMR (129 MHz, CDCl₃): δ=−3564 (s).—IR (ATR) [cm⁻¹]: v⁻¹=3335 (vw), 3049 (vw), 2988 (vw), 2937 (w), 1799 (vw), 1568 (m), 1465 (w), 1420 (m), 1371 (vw), 1338 (vw), 1315 (vw), 1258 (w), 1206 (vw), 1171 (vw), 1098 (vw), 1077 (vw), 1059 (w), 1020 (m), 894 (vw), 863 (vw), 844 (vw), 790 (m), 728 (m), 693 (m), 655 (vw), 609 (vw), 551 (vw), 496 (vw), 474 (w).—MS (70 eV, El), m/z (%): 472/471/470 (8/8/6) [M⁺], 318/317/316&315/314 (25/30/36/11/15) [M⁺-2×C₆H₅], 107 (65) [C₈H₁₁].—HRMS (PtC₂₁H₂₄): calc. 471.1525; found 471.1526.—EA (PtC₂₁H₂₄): calc. C, 53.49; H, 5.13; found C, 53.61; H, 5.17.

### Example 10

### Dichlorido-η⁴-((1Z,5Z)-1-ethylcycloocta-1,5-dien)platin PtCl₂(Et-COD)]

The compound was prepared according to the general procedure for the synthesis of platinum complexes of example 1. 453 mg (6.90 eq., 3.32 mmol) (1Z,5Z)-1-ethylcycloocta-1,5-diene was stirred with 200 mg (1.00 eq., 0.482 mmol) K₂PtCl₄, 2.15 mL nPrOH, 3.12 mL H₂O and 4.00 mg (0.0300 eq., 0.0210 mmol) SnCl₂ for two days. 172 mg (0.424 mmol, 88%) of the desired product could be obtained as beige solid.—Decomposition temperature: >144° C.—¹H NMR (400 MHz, CDCl₃): δ (ppm)=1.30 (t, ³J=7.3 Hz, 3H, CH₃), 1.82-2.12 (m, 3H, CH₂), 2.30-2.64 (m, 5H, CH₂), 2.76-2.90 (m, 2H, CH₂CH₃), 5.37-5.73 (m, 3H, CH).—¹³C-NMR (100 MHz, CDCl₃): 12.4 (+, CH₃), 28.3 (−, CH₂), 32.7 (−, CH₂), 33.1 (−, CH₂), 33.9 (−, CH₂), 34.7 (−, CH₂), 96.7 (+, CH), 98.5 (+, CH), 99.2 (+, CH), 128.4 (C_{quart}).—¹⁹⁵Pt-NMR (129 MHz, CDCl₃): δ (ppm)=−3315 (s).—IR (ATR) [cm⁻¹]: v⁻¹=3409 (vw), 3009 (vw), 2962 (vw), 2930 (vw), 2877 (w), 2834 (vw), 1655 (vw), 1506 (vw), 1491 (vw), 1461 (vw), 1430 (m), 1371 (vw), 1344 (vw), 1316 (w), 1250 (w), 1235 (vw), 1212 (vw), 1187 (vw), 1172 (vw), 1146 (vw), 1105 (vw), 1080 (vw), 1052 (w), 1032 (vw), 1011 (m), 963 (w), 927 (vw), 901 (vw), 878 (w), 857 (vw), 836 (m), 804 (w), 742 (vw), 696 (w), 670 (vw), 620 (w), 528 (vw), 468 (w), 424 (vw).—MS (70 eV, El), m/z (%): 404/402/401/400 (1/1/1/1) [M⁺], 367/366/365/364/363 (21/19/52/48/42) [M⁺−Cl], 332/331/329/328/327/326/325 (17/12/74/100/97/26/26) [M⁺−2×Cl], 107 (4) [C₈H₁₁].—HRMS (PtCl₂C₁₀H₁₆): calc. 401.0277; found. 401.0275.—EA (PtCl₂C₁₀H₁₆): calc. C, 29.86; H, 4.01; found C, 31.14; H, 4.07.

### Example 11

### η⁴-((1Z,5Z)-1-Ethylcycloocta-1,5-diene)diiodido platinum [PtI₂(Et-COD)]

The compound was prepared according to the general procedure for the synthesis of platinum complexes of example 2. 142 mg (1.00 eq., 0.353 mmol) [PtCl₂(Et-COD)] and 114 mg (2.15 eq., 0.760 mmol) NaI in 8.5 mL acetone were stirred together for three hours. 206 mg (0.351 mmol, 99%) of the desired product could be obtained as yellow solid.—Decomposition temperature: >104° C.—¹H-NMR (400 MHz, CDCl₃): (ppm)=1.24 (t, ³J_{HH}=7.3 Hz, 3H, CH₃), 1.70-2.58 (m, 8H, CH₂), 2.62-2.82 (m, 2H, CH₂CH₃), 5.52-5.82 (m, 2H, CH), 5.92 (d d, ³J_{HH}=6.3 Hz, ²J_{PtH}=53.0 Hz, 1H, CH).—¹³C-NMR (100 MHz, CDCl₃): δ (ppm)=12.0 (+, CH₃), 28.5 (−, CH₂), 31.9 (−, CH₂), 32.9 (−, CH₂), 35.2 (−, CH₂), 37.1 (−, CH₂), 99.3 (+, CH), 99.7 (+, CH), 100.9 (+, CH), 133.7 (C_{quart}).—¹⁹⁵Pt-NMR (129 MHz, CDCl₃): δ (ppm)=−4268 (s).—IR (ATR) [cm⁻¹]: v⁻¹=2924 (w), 2876 (vw), 2828 (vw), 1655 (vw), 1479 (w), 1448 (w), 1424 (m), 1374 (w), 1353 (vw), 1336 (w), 1304 (w), 1245 (w), 1184 (vw), 1169 (vw), 1143 (vw), 1094 (w), 1067 (w), 1039 (vw), 1002 (w), 977 (vw), 951 (w), 921 (vw), 893 (vw), 876 (w), 851 (vw), 828 (m), 798 (vw), 745 (w), 694 (vw), 554 (vw), 530 (w), 462 (vw), 433 (vw).—UV/Vis (CHCl₃): λₘₐₓ (log ∈)=227 (0.57), 229 (0.57), 250 (0.66), 299 (0.15), 382 (0.04) nm. MS (70 eV, El), m/z (%): 587/586/585/584/583 (19/7/81/100/91) [M⁺], 461/459/458/457/456/455/453 (8/43/36/72/18/46/11) [M⁺−I], 331/330/329/328/327/326/325 (28/34/53/35/45/22/27) [M⁺−2×I], 136 (18) [C₁₀H₁₆^{+],} 121 (8) [C₉H₁₃⁺], 107 (33) [C₈H₁₁⁺].—HRMS (PtI₂C₁₀H₁₆): calc. 584.8989; found 584.8992.—EA (PtI₂C₁₀H₁₆): calc. C, 20.53; H, 2.76; found C, 22.10; H, 2.84.

### Example 12

### η⁴-((1Z,5Z)-1-Ethylcycloocta-1,5-diene)dimethyl platinum [PtMe₂(Et-COD)]

The compound was prepared according to the general procedure for the synthesis of platinum complexes of example 3. 125 mg (1.00 eq., 0.214 mmol) [PtI₂(Et-COD)] and 430 μL MeLi (1.6 M in pentane, 3.00 eq., 0.641 mmol) were stirred together for two hours at 0° C. and then worked up. 63.3 mg (0.175 mmol, 82%) of the desired product could be obtained as yellow oil.—¹H-NMR (400 MHz, CDCl₃): δ (ppm)=0.69 (s d, ²J_{PtH}=81.4 Hz, 6H, CH₃), 1.06 (t, ³J_{HH}=7.4 Hz, 3H, CH₃), 1.88-2.56 (m, 10H, CH₂), 5.28-5.37 (m, 1H, CH), 5.45-6.64 (m, 2H, CH).—¹³C-NMR (100 MHz, CDCl₃): δ (ppm)=3.7 (+, PtCH₃), 9.3 (+, PtCH₃), 13.8 (+, CH₃), 27.3 (−, CH₂), 28.1 (−, CH₂), 31.3 (−, CH₂), 32.6 (−, CH₂), 33.2 (−, CH₂), 97.7 (+, s d, ¹J_{Ptc}=61.2 Hz, CH), 97.7 (+, s d, ¹J_{Ptc}=55.2 Hz, CH), 98.9 (+, s d, ¹J_{Ptc}=46.0 Hz, CH), 141.3 (C_{quart}).—¹⁹⁵Pt-NMR (129 MHz, CDCl₃): δ (ppm)=3534 (s).—IR (KBr) [cm⁻¹]: v⁻¹=3442 (vw), 2927 (m), 2877 (vw), 1736 (vw), 1482 (vw), 1429 (w), 1374 (vw), 1339 (vw), 1315 (vw), 1216 (vw), 1099 (vw), 1056 (vw), 1001 (vw), 935 (vw), 870 (vw), 787 (vw), 540 (vw).—MS (70 eV, El), m/z (%): 364/362/361/360 (4/18/22/19) [M⁺], 347/346/345 (7/8/7) [M⁺−CH₃], 333/332/331/330/329/328/327/326 (14/13/75/69/100/67/77/21) [M⁺−2×CH₃], 107 (5) [C₈H₁₁⁺].—HRMS (PtC₁₂H₂₂): calc. 361.1370; found 361.1371.

### Example 13

### η⁴-((1Z,5Z)-1-ethylcycloocta-1,5-dien)diphenyl platinum [PtPh₂(Et-COD)]

The compound was prepared according to the general procedure for the synthesis of platinum complexes of example 4. 20.0 mg (1.00 eq., 49.7 μmol) [PtCl₂(Et-COD)] was reacted with 50.0 μL (2 M in THF, 2.20 eq., 0.110 mmol) PhMgCl. 18.2 mg (37.3 μmol, 75%) of the desired product could be obtained as colorless solid.—¹H-NMR (400 MHz, CDCl₃): δ=0.94 (t, ³J=7.0 Hz, 3H, CH₃), 1.88 (q, ³J=7.0 Hz, 2H, CH₂), 2.15-2.80 (m, 8H, CH₂), 4.85-5.10 (m, 3H, CH), 6.80-6.88 (m, 3H, C_{Ar}H), 6.88-7.00 (m, 3H, C_{Ar}H), 7.00-7.20 (m, 1H, C_{Ar}H), 7.20-7.30 (m, 4H, C_{Ar}H).—¹⁹⁵Pt-NMR (129 MHz, CDCl₃): δ=−3557 (s).—IR (KBr) [cm⁻¹]: v⁻¹=3345 (br), 3057 (w), 2927 (m), 1944 (w), 1876 (w), 1711 (vw), 1595 (m), 1569 (m), 1500 (w), 1480 (m), 1429 (m), 1375 (w), 1344 (w), 1263 (w), 1170 (w), 1073 (m), 1023 (w), 903 (m), 812 (w), 730 (m), 697 (m), 610 (w), 509 (vw), 461 (w).—MS (70 eV, El), m/z (%): 486/485/484 (13/16/12) [M⁺], 332/330/329/328/326 (9/35/42/41/8) [M⁺−2×Ph], 136 (12) [C₁₀H₁₆⁺], 121 (12) [C₉H₁₁₃⁺], 107 (100) [C₈H₁₁⁺], 91 (49) [C₇H₇⁺], 67 (35) [C₆H₁₇⁺].—HRMS (PtC₂₂H₂₆): calc. 485.1682 found 485.1685.

### Example 14

### Dichlorido-η⁴-((1E,5Z)-1-phenylcycloocta-1,5-diene)platinum [PtCl₂(Ph-COD)]

The compound was prepared according to the general procedure for the synthesis of platinum complexes of example 1. 305 mg (6.90 eq., 1.66 mmol) (1E,5Z)-1-phenylcycloocta-1,5-diene was reacted with 100 mg (1.00 eq., 0.241 mmol) K₂PtCl₄, 1.08 mL nPrOH, 1.56 mL H₂O and 2.00 mg (0.0300 eq., 1.00 μmol) SnCl₂ for two days. 63.1 mg (1.26 mmol, 76%) of the desired product could be obtained as yellow solid.—Decomposition temperature: >200° C.—¹H-NMR (400 MHz, CDCl₃): δ=2.00-2.15 (m, 1H, CH₂), 2.35-2.52 (m, 2H, CH₂), 2.53-2.73 (m, 2H, CH₂), 2.78-2.93 (m, 1H, CH₂), 2.96-3.09 (m, 1H, CH₂), 3.11-3.24 (m, 1H, CH₂), 5.59-5.89 (m, 2H, CH), 6.04-6.28 (m, 1H, CH), 7.32-7.36 (m, 2H, C_{Ar}H), 7.37-7.43 (m, 1H, C_{Ar}H), 7.51-7.56 (d, ³J=7.3 Hz, 2H, C_{Ar}H).—¹³C-NMR (100 MHz, CDCl₃): δ=29.3 (−, CH₂), 32.7 (−, CH₂), 33.4 (−, CH₂), 38.1 (−, CH₂), 91.8 (+, CH), 98.3 (+, CH), 100.4 (+, CH), 120 (C_{quart}), 127.7 (+, C_{Ar}H), 128.4 (+, C_{Ar}H), 130.1 (+, C_{Ar}H).—¹⁹⁵Pt-NMR (129 MHz, CDCl₃): δ=−3191 (s).—IR (ATR) [cm⁻¹]: v⁻¹=3015 (w), 2882 (w), 2829 (vw), 1595 (w), 1571 (vw), 1523 (w), 1483 (m), 1449 (w), 1420 (w), 1339 (w), 1302 (vw), 1273 (vw), 1191 (w), 1095 (vw), 1074 (w), 1024 (w), 989 (w), 978 (vw), 921 (w), 874 (vw), 849 (w), 807 (w), 756 (m), 737 (w), 696 (m), 635 (vw), 598 (w), 529 (w), 499 (m).—MS (70 eV, El), m/z (%): 451/450/449/448/447 (8/8/15/11/9) [M⁺], 416/414/413/412 (6/16/16/13) [M⁺−Cl], 379/378/377 (6/7/12) [M⁺−2×Cl], 184 (98) [C₁₄H₁₆⁺], 129 (100) [C₁₀H₉⁺], 107 (13) [C₈H₁₁⁺].—HRMS (C₁₆H₂₂Cl₂Pt): calc. 449.0277; found 449.0275.

### Example 15

### Diiodido-η⁴-((1E,5Z)-1-phenylcycloocta-1,5-dien)platinum [PtI₂(Ph-COD)]

The compound was prepared according to the general procedure for the synthesis of platinum complexes of example 2. 50.0 mg (1.00 eq., 0.111 mmol) [PtCl₂(Ph-COD)] and 35.8 mg (2.15 eq., 0.238 mmol) NaI in 3 mL acetone were stirred together for three hours. 73.9 mg (0.110 mmol, 99%) of the desired product could be obtained as orange solid.—Decomposition temperature: >151° C.—¹H-NMR (400 MHz, CDCl₃): δ=1.78-1.98 (m, 1H, CH₂), 2.00-2.55 (m, 4H, CH₂), 2.55-2.73 (m, 1H, CH₂), 2.78-2.93 (m, 1H, CH₂), 3.04-3.18 (m, 1H, CH₂), 5.75-6.05 (m, 2H, CH₂), 6.39 (td, ³J=7.0 Hz, ²J_{PtH}=34.4 Hz, 1H, CH₂), 7.31-7.40 (m, 3H, C_{Ar}H), 7.48-7.55 (m, 2H, C_{Ar}H).—¹³C-NMR (100 MHz, CDCl₃): δ=29.7 (−, CH₂), 33.1 (−, CH₂), 35.2 (−, CH₂), 36.5 (−, CH₂), 94.8 (+, CH), 100.5 (+, CH), 102.0 (+, CH), 125.5 (C_{quart}), 126.2 (+, C_{Ar}H), 127.5 (+, C_{Ar}H), 128.1 (+, C_{Ar}H), 129.8 (+, C_{Ar}H), 142.3 (+, C_{Ar}H).—¹⁹⁵Pt-NMR (129 MHz, CDCl₃): δ=−4150 (s).—IR (ATR) [cm⁻¹]: v⁻¹=3052 (vw), 3013 (vw), 2915 (vw), 2873 (w), 1653 (vw), 1595 (w), 1473 (w), 1439 (w), 1426 (vw), 1410 (vw), 1339 (w), 1305 (w), 1253 (vw), 1208 (vw), 1180 (vw), 1166 (vw), 1099 (vw), 1073 (vw), 1026 (vw), 1008 (vw), 987 (vw), 950 (w), 906 (vw), 881 (w), 856 (w), 832 (vw), 798 (w), 758 (w), 741 (m), 693 (m), 647 (vw), 586 (w), 551 (w), 514 (vw), 486 (vw), 454 (w).—UV/Vis (CHCl₃): λₘₐₓ (log ∈)=231 (0.78), 296 (0.37), 382 (0.07), 394 (0.07) nm.—MS (70 eV, El), m/z (%): 635/633/632/631 (5/26/33/26) [M⁺], 508/506/505/504 (8/33/39/36) [M⁺−I], 379/378/377/375 (6/11/17/11) [M⁺−2×I], 185/184 (18/100) [C₁₆H₁₆⁺], 129 (87) [C₁₀H₉⁺], 115 (65) [C₉H₇⁺].—HRMS (C₁₆H₂₂I₂Pt): calc. 632.8989; found 632.8992.—EA (C₁₆H₂₂I₂Pt): calc. C, 26.56; H, 2.55; found C, 27.67; H, 2.66.

### Example 16

### Dimethyl-η⁴-((1E,5Z)-1-phenylcycloocta-1,5-diene)platinum [PtMe₂(Ph-COD)]

The compound was prepared according to the general procedure for the synthesis of platinum complexes of example 3. 30.0 mg (1.00 eq., 47.3 μmol) [PtMe₂(Ph-COD)] and 95.0 μL (1.6 M in pentane, 3.00 eq., 0.142 mmol) MeLi were stirred together for two hours at 0° C. and then worked up. 15.5 mg (37.4 μmol, 79%) of the desired product could be obtained as a slightly yellow solid.—Decomposition temperature: >100° C.—¹⁹⁵Pt-NMR (129 MHz, CDCl₃): δ=−3401 (s).—IR (ATR) [cm⁻¹]: v⁻¹=2917 (vw), 2871 (w), 1595 (w), 1475 (w), 1439 (w), 1340 (w), 1307 (w), 1257 (w), 1179 (vw), 1095 (vw), 1075 (w), 1001 (m), 947 (w), 881 (w), 856 (w), 832 (vw), 798 (m), 756 (m), 742 (w), 691 (m), 648 (vw), 621 (w), 606 (w), 588 (w), 553 (m), 514 (w), 485 (w), 457 (w), 406 (w).—MS (70 eV, El), m/z (%): 412/411/410/409/408 (1/1/1/1/1) [M⁺], 397/395/394/393 (1/1/1/1) [M⁺−CH₃], 379/378/377 (1/1/1) [M⁺−2×CH₃], 184 (100) [C₁₆H₁₆⁺], 143 (92) [C₁₁H₁₁⁺], 130 (84) [C₁₀H₁₀⁺], 115 (22) [C₉H₇⁺], 107 (1) [C₈H₁₁⁺].—HRMS (C₁₈H₂₈Pt): calc. 409.1369; found 409.1367.

### Example 17

### Diphenyl-η⁴-((1E,5Z)-1-phenylcycloocta-1,5-diene)platinum [PtPh₂(Ph-COD)]

The compound was prepared according to the general procedure for the synthesis of platinum complexes of example 4. 10.0 mg (1.00 eq., 22.2 μmol) [PtCl₂(Ph-COD)] was reacted with 22.0 μL (2 M in tetrahydrofuran, 2.20 eq., 48.8 μmol) PhMgCl. 6.00 mg (11.1 μmol, 50%) of the desired product could be obtained as slightly yellow solid.—¹⁹⁵Pt-NMR (129 MHz, CDCl₃): δ=−3548 (s).—IR (KBr) [cm⁻¹]: v⁻¹=3355 (br), 3033 (w), 2930 (vw), 1944 (w), 1876 (w), 1748 (vw), 1595 (m), 1569 (w), 1499 (w), 1479 (m), 1453 (vw), 1429 (w), 1374 (vw), 1344 (w), 1235 (m), 1169 (w), 1074 (m), 1024 (vw), 1008 (w), 903 (m), 812 (w), 754 (vw), 737 (m), 697 (m), 610 (w), 544 (vw), 508 (w), 460 (vw).—MS (70 eV, El), m/z (%): 536/535/534/533/532/530 (1/1/1/1/1/1) [M⁺], 458/457/456 (1/1/1) [M⁺−C₆H₅], 379/378/377 (1/1/1) [M⁺−2×C₆H₅], 184 (6) [C₁₄H₁₆⁺], 166 (24) [C₁₃H₁₀⁺], 107 (100) [C₈H₁₁⁺].—HRMS (C₂₈H³²Pt): calc. 533.1683 found 533.1680.

### Example 18

### Dichlorido-η⁴-((1E,5Z)-1-isopropylcycloocta-1,5-diene)platinum [PtCl₂(iPr-COD)]

The compound was prepared according to the general procedure for the synthesis of platinum complexes of example 1. 250 mg (6.90 eq., 1.66 mmol) (1E,5Z)-1-isopropylcycloocta-1,5-diene was reacted with 105 mg (1.00 eq., 0.241 mmol) K₂PtCl₄, 1.10 mL n-PrOH, 1.60 mL H₂O and 2.00 mg (0.0300 eq., 10.0 μmol) SnCl₂ for two days. 95.5 mg (0.219 mmol, 91%) of the desired product could be obtained as a slightly yellow solid.—Decomposition temperature: >150° C.—¹H-NMR (400 MHz, CDCl₃): δ (ppm)=0.95 (d, ³J_{HH}=6.9 Hz, 6H, CH₃), 2.20 (sept, ³J_{HH}=6.9 Hz, 1H, CH(CH₃)₂), 2.25-2.42 (m, 8H, CH₂), 5.46-5.56 (m, 2H, CH), 5.56-5.66 (m, 1H, CH).—¹³C-NMR (100 MHz, CDCl₃): δ (ppm)=21.0 (+, 2×CH₃), 26.3 (−, CH₂), 27.2 (−, CH₂), 27.7 (−, CH₂), 29.9 (−, CH₂), 36.4 (+, CH), 119.5 (+, CH), 127.6 (+, CH), 127.7 (+, CH), 144.2 (C_{quart}).—¹⁹⁵Pt-NMR (129 MHz, CDCl₃): δ (ppm)=3307 (s). IR (ATR) [cm⁻¹]: v⁻¹=3009 (vw), 2963 (w), 2928 (vw), 2885 (vw), 1654 (vw), 1481 (vw), 1459 (vw), 1424 (w), 1381 (vw), 1360 (vw), 1336 (vw), 1308 (w), 1251 (vw), 1194 (vw), 1176 (vw), 1089 (vw), 1062 (w), 1036 (vw), 1025 (vw), 1010 (m), 968 (vw), 887 (vw), 859 (w), 829 (w), 800 (vw), 778 (vw), 734 (vw), 697 (vw), 664 (vw), 612 (w), 580 (vw), 542 (vw), 500 (vw), 468 (w).—MS (70 eV, El), m/z (%): 419/418/417/416/415/414/412 (1/1/1/1/1/1/1) [M⁺], 382/381/380/379/378 (7/6/16/16/15) [M⁺−Cl], 344/343/342/341/340 (29/36/38/14/14) [M⁺−2×Cl], 300/299/298/297 (13/11/25/12), 150 (24) [C₁₁H₁₈⁺], 135 (25) [C₁₀H₁₅⁺], 107 (77) [C₈H₁₁⁺], 91 (52), 81 (100), 79 (97), 67 (59), 43 (45). HRMS (PtCl₂C₁₁H₁₈): calc. 415.0434; found 415.0437.

### Example 19

### Diiodido-η⁴-((1E,5Z)-1-isopropylcycloocta-1,5-diene)platinum PtI₂(iPr-COD)]

The compound was prepared according to the general procedure for the synthesis of platinum complexes of example 2. 10.0 mg (1.00 eq., 0.0240 mmol) [PCl₂(iPr-COD)] and 7.70 mg (2.15 eq., 51.6 μmol) NaI in 0.50 mL acetone were stirred together for three hours. 14.0 mg (0.0230 mmol, 97%) of the desired product could be obtained as yellow solid.—¹H-NMR (300 MHz, CDCl₃): δ (ppm)=0.95 (dd, ²J_{HH}=64.0 Hz, ³J_{HH}=6.7 Hz, 6H, CH₃), 2.32-2.80 (m, 8H, CH₂), 3.38 (sept, ³J=6.7 Hz, 1H, CH(CH₃)₂), 5.52-5.92 (m, 3H, CH).—¹³C-NMR (100 MHz, CDCl₃): δ (ppm)=21.2 (+, 2×CH₃), 26.4 (−, CH₂), 27.9 (−, CH₂), 28.8 (−, CH₂), 30.2 (−, CH₂), 38.3 (+, CH), 121.1 (+, CH), 130.2 (+, CH), 130.6 (+, CH), 148.0 (C_{quart}).—¹⁹⁵Pt-NMR (129 MHz, CDCl₃): δ (ppm)=4255 (s).—IR (ATR) [cm¹]: v⁻¹=3006 (vw), 2923 (w), 2880 (vw), 1655 (vw), 1499 (vw), 1475 (w), 1424 (w), 1374 (vw), 1337 (w), 1308 (vw), 1222 (vw), 1172 (w), 1086 (w), 1067 (vw), 1036 (vw), 1004 (w), 961 (vw), 907 (vw), 887 (vw), 865 (w), 824 (w), 799 (w), 776 (vw), 732 (w), 694 (w), 608 (w), 569 (vw), 502 (vw), 459 (m).—MS (70 eV, El), m/z (%): 598/597 (14/13) [M⁺], 557/556/555 (18/16/24), 507/506/505 (24/23/22), 471/470/469 (13/17/13) [M⁺I], 380/379 (27/24), 345/344/343/342/341/340 (41/72/100/69/50/25) [M⁺-2×I], 150 (13) [C₁₁H₁₈⁺], 135 (14) [C₁₀H₁₅⁺], 107 (36) [C₈H₁₁⁺], 91 (39), 79 (53), 67 (35), 43 (21).—HRMS (PtI₂C₁₁H₁₈): calc. 598.9146; found 598.9142.

### Example 20

### η⁴-((1E,5Z)-1-Isopropylcycloocta-1,5-dien)dimethylplatin [PtMe₂(iPr-COD)]

The compound was prepared according to the general procedure for the synthesis of platinum complexes of example 5. 374 mg (1.00 eq., 950 μmol) Pt(acac)₂ and 157 mg (1.10 eq., 1.04 mmol) (1E,5Z)-1-isopropylcycloocta-1,5-diene were dissolved in toluene (37 mL) and 1.43 mL (2.0 m in toluene, 3.00 eq., 2.85 mmol) AlMe₃ was added dropwise. The reaction mixture was worked up after 24 hours. 168 mg (448 μmol, 47%) of the desired product could be obtained as a slightly yellow solid.—Melting point: 54° C.—¹H-NMR (400 MHz, CDCl₃): δ (ppm)=0.62 (d d, ²J_{PtH}=81.2 Hz, ³J_{HH}=2.4 Hz, 6H, CH(CH₃)₂), 0.90 (d, ³J_{HH}=6.9 Hz, 3H, CH₃), 1.05 (d, ³J_{HH}=6.9 Hz, 3H, CH₃), 1.80-1.92 (m, 1H, CH(CH₃)₂), 1.94-2.16 (m, 3H, CH₂), 2.20-2.50 (m, 4H, CH₂), 2.54-2.66 (m, 1H, CH₂), 4.42-4.58 (m, 1H, CH), 4.61-4.82 (m, 2H, CH).—¹³C-NMR (100 MHz, CDCl₃): δ (ppm)=3.9 (+, 2×PtCH₃), 9.2 (+, 2×CH(CH₃)₂), 26.5 (−, CH₂), 27.1 (−, CH₂), 32.2 (−, CH₂), 33.3 (−, CH₂), 36.8 (+, CH(CH₃)₂), 97.0 (+, s d, ¹J_{Ptc}=62.6 Hz, CH), 97.9 (+, s d, ¹J_{Ptc}=57.2 Hz, CH), 99.1 (+, s d, ¹J_{Ptc}=47.6 Hz, CH), 124.2 (C_{quart}).—¹⁹⁵Pt-NMR (129 MHz, CDCl₃): δ (ppm)=−3526 (s).—IR (ATR) [cm⁻¹]: v⁻¹=3442 (vw), 2957 (m), 2927 (vw), 2874 (w), 2834 (vw), 2797 (vw), 1524 (vw), 1483 (vw), 1462 (vw), 1431 (w), 1381 (vw), 1358 (vw), 1340 (vw), 1310 (vw), 1284 (vw), 1216 (vw), 1196 (vw), 1165 (vw), 1088 (vw), 1065 (w), 1037 (vw), 999 (vw), 956 (vw), 925 (vw), 875 (vw), 859 (vw), 814 (vw), 783 (vw), 729 (vw), 603 (vw), 557 (vw), 538 (vw), 450 (vw).—MS (70 eV, El), m/z (%): 376/375/374 (9/11/11) [M⁺], 361/360/359 (9/12/9) [M⁺−CH₃], 345/344/343/342/341/340/339 (55/66/100/75/70/21/22) [M⁺−2×CH₃], 299 (11), 297 (12), 91 (14), 77 (10).—HRMS (PtC₁₃H₂₄): calc. 375.1526; found 375.1524.

### Example 21

### η⁴-((1Z,5Z)-1-isopropylcycloocta-1,5-diene)diphenylplatinum [PtPh₂(iPr-COD)]

The compound was prepared according to the general procedure for the synthesis of platinum complexes of example 5. 30.0 mg (1.00 eq., 89.0 μmol) [PtCl₂(iPr-COD)] was reacted with 88.0 μL (2 M in tetrahydrofuran, 2.20 eq., 0.196 mmol) PhMgCl. 12.7 mg (29.4 μmol, 35%) of the desired product could be obtained as a slightly yellow solid.—IR (KBr) [cm⁻¹]: v⁻¹=3233 (br), 3031 (vw), 2925 (w), 1657 (vw), 1593 (w), 1569 (vw), 1535 (vw), 1475 (w), 1429 (vw), 1377 (vw), 1169 (w), 1041 (m), 903 (vw), 754 (vw), 735 (m), 695 (m), 608 (vw), 544 (vw), 510 (w).—MS (70 eV, El), m/z (%): 500/499/498 (24/28/23) [M⁺], 347/346/345/344/343/342/341 (20/24/22/64/74//77/28) [M⁺−2×Ph], 297 (18), 281 (17), 230 (23), 183 (41), 150 (20) [C₁₁H₁₈], 135 (23) [C₁₀H₁₅⁺], 131 (74), 121 (30) [C₉H₁₃⁺], 107 (73) [C₈H₁₁⁺], 95 (35) [C₇H₁₁+], 91 (98), 81 (83) [C₆H₁₉⁺], 79 (100), 67 (53) [C₅H₁₇⁺], 43 (64) [C₃H₁₇⁺].—HRMS (C₂₃H₂₈Pt): calc. 499.1839; found 499.1839.

### Example 22

### Dichlorido-η⁴-(1E,5Z)-1-n-butylcycloocta-1,5-diene)platinum [PtCl₂(nBu-COD)]

The compound was prepared according to the general procedure for the synthesis of platinum complexes of example 1. 503 mg (6.90 eq., 3.06 mmol) (1E,5Z)-1-n-butylcycloocta-1,5-diene was reacted with 184 mg (1.00 eq., 0.444 mmol) K₂PtCl₄, 2.03 mL n-PrOH, 2.95 mL H₂O and 2.50 mg (0.0300 eq., 13.3 μmol) SnCl₂ for five days. 180 mg (0.418 mmol, 94%) of the desired product could be obtained as a slightly yellow solid.—Decomposition temperature: >143° C.—¹H-NMR (400 MHz, CDCl₃): δ (ppm)=0.86 (t, ³J=7.2 Hz, 3H, CH₃), 1.19-1.33 (m, 2H, CH₂), 1.40-1.48 (m, 1H, CH₂), 1.74-2.04 (m, 4H, CH₂), 2.16-2.57 (m, 5H, CH₂), 2.70-2.81 (m, 2H, CH₂), 5.42-5.34 (m, 3H, CH).—¹³C-NMR (100 MHz, CDCl₃): δ (ppm)=13.8 (+, CH₃), 22.7 (−, CH₂), 28.4 (−, CH₂), 30.2 (−, CH₂), 32.4 (−, CH₂), 32.8 (−, CH₂), 34.3 (−, CH₂), 41.3 (−, CH₂), 96.7 (+, CH), 98.2 (+, CH), 99.3 (+, CH), 128.1 (C_{quart}).—¹⁹⁵Pt-NMR (129 MHz, CDCl₃): δ (ppm)=3307 (s). IR (KBr) [cm⁻¹]: v⁻¹=2956 (s), 2929 (w), 2867 (s), 1502 (vs), 1484 (m), 1464 (s), 1431 (w), 1412 (s), 1379 (s), 1335 (s), 1317 (m), 1246 (s), 1191 (s), 1171 (vs), 1098 (m), 1083 (s), 1041 (s), 1009 (w), 975 (s), 948 (s) 919 (m), 901 (s), 876 (m), 854 (s), 836 (m), 803 (m), 763 (s), 727 (s), 699 (s), 567 (vw), 549 (vs), 477 (m), 437 (s), 421 (s), 404 (s). MS (70 eV, El), m/z (%): 396/395/394/393/392 (14/12/37/37/27) [M⁺−Cl], 358/357/356/355/354 (61/69/100/71/72)[M⁺−2×Cl], 164 (23) [C₁₂H₂₀⁺], 107 [C₈H₁₁⁺], 79 (22), 68 (16), 41 (10).—HRMS (M⁺−Cl, C₁₂H₂₀ClPt): calc. 394.0902; found 394.0901.

### Example 23

### Diiodido-η⁴-((1E,5Z)-1-n-butylcycloocta-1,5-diene)platinum [PtI₂(nBu-COD)]

The compound was prepared according to the general procedure for the synthesis of platinum complexes of example 2. 140 mg (1.00 eq., 0.325 mmol) [PCl₂(nBu-COD)] and 105 mg (2.15 eq., 0.700 mmol) NaI in 8 mL acetone were stirred together for three hours. 169 mg (0.276 mmol, 85%) of the desired product could be obtained as an orange wax.—¹H-NMR (400 MHz, CDCl₃): δ (ppm)=0.85 (t, ³J=7.2 Hz, 3H, CH₃), 1.19-1.31 (m, 2H, CH₂), 1.34-1.43 (m, 1H, CH₂), 1.67-2.07 (m, 6H, CH₂), 2.10-2.20 (m, 1H, CH₂), 2.34-2.40 (m, 1H, CH₂), 2.47-2.76 (m, 3H, CH₂), 5.45-5.94 (m, 3H, CH).—¹³C-NMR (100 MHz, CDCl₃): δ (ppm)=13.8 (+, CH₃), 22.4 (−, CH₂), 28.6 (−, CH₂), 29.8 (−, CH₂), 32.4 (−, CH₂), 32.8 (−, CH₂), 35.0 (−, CH₂), 43.8 (−, CH₂), 99.3 (+, CH), 99.4 (+, CH), 100.7 (+, CH), 133.4 (C_{quart}).—¹⁹⁵Pt-NMR (129 MHz, CDCl₃): δ (ppm)=−4262 (s). IR (KBr) [cm⁻¹]: v⁻¹=3480 (s), 2950 (vw), 2923 (s), 2856 (s), 1699 (vs), 1503 (s), 1477 (s), 1463 (s), 1424 (vw), 1374 (s), 1341 (s), 1311 (m), 1237 (s), 1188 (s), 1169 (s), 1096 (m), 1039 (s), 1004 (m), 968 (s), 934 (m), 918 (s), 893 (s), 873 (m), 851 (s), 828 (m), 799 (s), 756 (s), 723 (m), 694 (vs), 619 (s), 561 (m), 465 (m). MS (70 eV, El), m/z (%): 616/614/613/612 (12/53/64/54) [M⁺], 487/486/485 (20/24/25) [M⁺−I], 359/358/357/356/355 (70/82/100/43/55) [C₁₂H₂₀Pt⁺], 164 (26) [C₁₂H₂₀⁺].—HRMS (C₁₂H₂₀PtI₂): calc. 612.9303; found 612.9304.

### Example 24

### η⁴-((1E,5Z)-1-n-Butylcycloocta-1,5-diene)dimethylplatinum [PtMe₂(nBu-COD)]

The compound was prepared according to the general procedure for the synthesis of platinum complexes of example 5. 218 mg (1.00 eq., 0.553 mmol) Pt(acac)₂ and 100 mg (1.10 eq., 0.609 mmol) (1E,5Z)-1-n-butylcycloocta-1,5-diene were dissolved in toluene (21 mL) and 0.834 mL (2 M in toluene, 3.00 eq., 1.66 mmol) AlMe₃ was added dropwise. The reaction mixture was worked up after 24 hours. 174 mg (0.446 mmol, 81%) of the desired product could be obtained as colorless oil.—¹H-NMR (400 MHz, CDCl₃): (ppm)=0.69 (s d, ²J_{PtH}=81.5 Hz, 6H, CH₃), 0.89 (d, ³J=7.2 Hz, 3H, CH₃), 1.19-1.38 (m, 3H, CH₂), 1.56-1.62 (m, 1H, CH₂), 1.84-1.99 (m, 1H, CH₂), 2.03-2.18 (m, 3H, CH₂), 2.20-2.26 (m, 2H, CH₂), 2.29-2.52 (m, 4H, CH₂), 4.64-4.80 (m, 3H, CH).—¹³C-NMR (100 MHz, CDCl₃): δ (ppm)=3.5 (+, PtCH₃), 9.5 (+, PtCH₃), 14.0 (+, CH₃CH₂), 22.7 (−, CH₂), 28.3 (−, CH₂), 30.9 (−, CH₂), 31.0 (−, CH₂), 31.5 (−, CH₂), 33.1 (−, CH₂), 40.2 (−, CH₂), 97.5 (+, s d, ¹J_{Ptc}=58.3 Hz, CH), 97.8 (+, s d, ¹J_{Ptc}=61.5 Hz, CH), 99.3 (+, s d, ¹J_{Ptc}=46.1 Hz, CH), 120.0 (C_{quart}).—¹⁹⁵Pt-NMR (129 MHz, CDCl₃): b (ppm)=−3530 (s).—IR (ATR) [cm⁻¹]: v⁻¹=3442 (vs), 2925 (vw), 2873 (s), 2834 (vs), 2797 (vs), 1656 (vs), 1525 (vs), 1480 (vs), 1464 (vs), 1431 (s), 1378 (vs), 1340 (vs), 1315 (vs), 1216 (vs), 1195 (vs), 1167 (vs), 1104 (vs), 1103 (vs), 999 (vs), 929 (vs), 88 (vs), 790 (vs), 730 (vs), 559 (vs), 539 (s). MS (70 eV, El), m/z (%): 390/389/380 (3/2/2) [M⁺], 375/374/373 (14/16/14) [M⁺−CH₃], 359/358/357/356/355/354/353 (32/70/66/85/100/48) [M⁺-2×CH₃].—HRMS (PtC₁₄H₂₆): calc. 389.1682; found 389.1681.

### Example 25

### Dichlorido-η⁴-((1E,5Z)-1-isobutylcycloocta-1,5-diene)platinum [PtCl₂(iBu-COD)]

The compound was prepared according to the general procedure for the synthesis of platinum complexes of example 1. 494 mg (6.90 eq., 3.01 mmol) (1E,5Z)-1-isobutylcycloocta-1,5-diene was reacted with 181 mg (1.00 eq., 0.436 mmol) K₂PtCl₄, 2.00 mL n-PrOH, 2.90 mL H₂O and 2.48 mg (0.0300 eq., 13.1 μmol) SnCl₂ for five days. 172 mg (0.400 mmol, 91%) of the desired product could be obtained as beige solid.—Decomposition temperature: >161° C.—¹H-NMR (400 MHz, CDCl₃): δ (ppm)=0.73 (d, ³J_{HH}=6.6 Hz, 3H, CH₃), 1.03 (d, ³J_{HH}=6.6 Hz, 3H, CH₃), 1.80-1.87 (m, 1H, CH), 2.00-2.08 (m, 2H, CH₂), 2.26-2.51 (m, 5H, CH₂), 2.56-2.63 (m, 1H, CH₂), 2.72-2.82 (m, 2H, CH₂), 5.49-5.63 (m, 3H, CH).—¹³C-NMR (100 MHz, CDCl₃): δ (ppm)=21.2 (+, CH₃), 23.9 (+, CH₃), 27.9 (+, CH), 29.2 (−, CH₂), 31.4 (−, CH₂), 31.6 (−, CH₂), 34.5 (−, CH₂), 50.1 (−, CH₂), 96.9 (+, CH), 97.1 (+, CH), 99.9 (+, CH), 128.0 (C_{quart}). —¹⁹⁵Pt-NMR (129 MHz, CDCl₃): δ (ppm)=3287 (s).—IR (KBr) [cm⁻¹]: V⁻¹=2955 (vw), 2927 (s), 2867 (s), 2349 (s), 1703 (s), 1502 (s), 1480 (s), 1462 (m), 1426 (s), 1384 (s), 1366 (s), 1343 (w), 1282 (s), 1242 (s), 1163 (s), 1108 (m), 1010 (m), 947 (s), 901 (s), 862 (w), 806 (s), 754 (s), 671 (s), 665 (s), 629 (m), 596 (s), 528 (s), 470 (m), 406 (s). MS (70 eV, El), m/z (%): 431/430/429/428 (1/1/1/1) [M⁺], 396/395/394/393/392 (17/17/42/40/34) [M⁺−Cl], 358/357/356/355/354 (53/61/100/72/79) [M⁺−2×Cl], 79 (12), 68 (4), 41 (19).—HRMS (C₁₂H₂₀Cl₂Pt): calc. 429.0590; found 429.0587.

### Example 26

### Diiodido-η⁴-((1E,5Z)-1-isobutylcycloocta-1,5-diene)platinum [PtI₂(iBu-COD)]

The compound was prepared according to the general procedure for the synthesis of platinum complexes of example 2. 85.4 mg (1.00 eq., 0.198 mmol) [PCl₂(iBu-COD)] and 64.0 mg (2.15 eq., 0.427 mmol) NaI in 3.5 mL acetone were stirred together for three hours. 116 mg (0.189 mmol, 96%) of the desired product could be obtained as an orange wax.—¹H-NMR (400 MHz, CDCl₃): δ (ppm)=0.78 (d, ³J_{HH}=6.6 Hz, 3H, CH₃), 1.01 (d, ³J_{HH}=6.6 Hz, 3H, CH₃), 1.74-1.89 (m, 3H, CH₂), 1.96-2.05 (m, 1H, CH), 2.17-2.23 (m, 1H, CH₂), 2.24-2.53 (m, 3H, CH₂), 2.58-2.76 (m, 3H, CH₂), 5.57-5.92 (m, 3H, CH).—¹³C-NMR (100 MHz, CDCl₃): δ (ppm)=21.3 (+, CH₃), 23.9 (+, CH₃), 28.5 (−, CH₂), 29.6 (−, CH₂), 31.8 (−, CH₂), 32.5 (−, CH₂), 33.3 (−, CH₂), 53.1 (+, CH), 98.3 (+, CH), 100.0 (+, CH), 101.0 (+, CH), 133.6 (C_{quart}).—¹⁹⁵Pt-NMR (129 MHz, CDCl₃): δ (ppm)=4225 (s).—IR (KBr) [cm⁻¹]: v⁻¹=3855 (s), 3650 (s), 2954 (vw), 2349 (s), 1654 (s), 1506 (s), 1458 (s), 1428 (vw), 1383 (s), 1311 (m), 1164 (s), 1105 (m), 1008 (s), 947 (s), 895 (s), 867 (s), 801 (m), 740 (s), 671 (s), 665 (s), 622 (m), 460 (m). MS (70 eV, El), m/z (%): 616/614/613/612 (14/60/74/65) [M⁺], 487/486/485/484/483 (31/35/45/25/21) [M⁺I], 359/358/357/356/355 (35/42/70/49/64) [C₁₂H₂₀Pt⁺], 164 (39) [C₁₂H₂₀⁺], 121 (72), 107 (99), 93 (67), 79 (100), 67 (82), 41 (56). HRMS (C₁₂H₂₀PtI₂): calc. 612.9303; found 612.9299.

### Example 27

### η⁴-((1E,5Z)-1-Isobutylcycloocta-1,5-diene)dimethylplatinum [PtMe₂(iBu-COD)]

The compound was prepared according to the general procedure for the synthesis of platinum complexes of example 5. 501 mg (1.00 eq., 1.27 mmol) Pt(acac)₂ and 230 mg (1.10 eq., 1.40 mmol) (1E,5Z)-1-isobutylcycloocta-1,5-diene were dissolved in toluene (45 mL) and 1.91 mL (2 M in toluene, 3.00 eq., 3.81 mmol) AlMe₃ was added dropwise. The reaction mixture was worked up after 24 hours. 386 mg (0.991 mmol, 78%) of the desired product could be obtained as a colorless solid.—Melting point: 65° C.—¹H-NMR (400 MHz, CDCl₃): δ (ppm)=0.69 (s d, ²J_{PtH}=81.3 Hz, 3H, PtCH₃), 0.71 (s d, ²J_{PtH}=81.6 Hz, 3H, PtCH₃), 0.74 (d, ³J_{HH}=6.1 Hz, 3H, CH₃), 0.93 (d, ³J_{HH}=6.2 Hz, 3H, CH₃), 1.62-1.73 (m, 2H, CH₂), 2.14-2.46 (m, 9H, 4×CH₂, CH), 4.62-4.75 (m, 3H, CH).—¹³C-NMR (100 MHz, CDCl₃): δ (ppm)=3.1 (+, s d, ¹J_{Ptc}=694 Hz, PtCH₃), 10.2 (+, s d, ¹J_{Ptc}=726 Hz, PtCH₃), 21.0 (+, CH₃CH), 23.8 (+, CH₃CH), 27.8 (−, CH₂), 29.1 (−, CH₂), 29.6 (−, CH₂), 30.2 (−, CH₂), 33.5 (−, CH₂), 49.7 (+, CH), 96.9 (+, s d, ¹J_{Ptc}=55.6 Hz, CH), 98.4 (+, s d, ¹J_{Ptc}=61.8 Hz, CH), 100.2 (+, s d, ¹J_{Ptc}=45.6 Hz, CH), 119.2 (+, s d, ¹J_{Ptc}=50.8 Hz, C_{quart}).—¹⁹⁵Pt-NMR (129 MHz, CDCl₃): δ (ppm)=3519 (s).—IR (ATR) [cm⁻¹]: v⁻¹=3451 (s), 2925 (vw), 2873 (s), 2834 (vs), 2798 (vs), 1658 (vs), 1641 (vs), 1563 (vs), 1567 (vs), 1526 (vs), 1480 (vs), 1463 (m), 1429 (s), 1383 (s), 1365 (s), 1343 (s), 1216 (vs), 1195 (vs), 1167 (s), 1110 (s), 998 (vs), 923 (s), 883 (vs), 863 (vs), 782 (vs), 735 (vs), 559 (vs), 540 (s).—MS (70 eV, El), m/z (%): 390/389/377 (4/5/4) [M⁺], 375/374/373 (14/22/19) [M⁺−CH₃], 359/358/357/356/355/354 (53/33/100/68/65/47) [M⁺−2×CH₃].—HRMS (PtC₁₄H₂₆): calc. 389.1682; found 389.1681.

### Example 28

### Dichlorido-η⁴-((1E,5Z)-1-n-hexylcycloocta-1,5-diene)platinum [PtCl₂(nHex-COD)]

The compound was prepared according to the general procedure for the synthesis of platinum complexes of example 1. 538 mg (6.90 eq., 2.80 mmol) (1E,5Z)-1-n-hexylcycloocta-1,5-diene was reacted with 168 mg (1.00 eq., 0.405 mmol) K₂PtCl₄, 1.85 mL n-PrOH, 2.69 mL H₂O and 2.30 mg (0.0300 eq., 0.0122 mmol) SnCl₂ for five days. 114 mg (0.249 mmol, 62%) of the desired product could be obtained as a slightly yellow solid.—Decomposition temperature: >124° C.—¹H-NMR (400 MHz, CDCl₃): δ (ppm)=0.82 (t, ³J=6.7 Hz, 3H, CH₃), 1.21-1.25 (m, 6H, CH₂), 1.39-1.45 (m, 1H, CH₂), 1.77-2.03 (m, 4H, CH₂), 2.26-2.55 (m, 5H, CH₂), 2.69-2.81 (m, 2H, CH₂), 5.35-5.57 (m, 3H, CH).—¹³C-NMR (100 MHz, CDCl₃): δ (ppm)=14.0 (+, CH₃), 22.5 (−, CH₂), 28.2 (−, CH₂), 28.4 (−, CH₂), 29.2 (−, CH₂), 31.4 (−, CH₂), 32.5 (−, CH₂), 32.7 (−, CH₂), 34.3 (−, CH₂), 41.6 (−, CH₂), 96.6 (+, CH), 98.1 (+, CH), 99.2 (+, CH), 127.9 (C_{quart}).—¹⁹⁵Pt-NMR (129 MHz, CDCl₃): δ (ppm)=3306 (s).—IR (KBr) [cm⁻¹]: v⁻¹=3014 (vs), 2954 (s), 2924 (vw), 2855 (s), 1504 (s), 1458 (s), 1429 (w), 1377 (vs), 1343 (s), 1316 (m), 1248 (s), 1195 (vs), 1174 (s), 1101 (s), 1045 (vs), 1012 (m), 961 (vs), 908 (s), 867 (m), 833 (s), 804 (s), 724 (s), 628 (m), 531 (s), 571 (m). MS (70 eV, El), m/z (%): 424/423/422/421/420 (3/3/9/7/7) [M⁺−Cl], 386/385/384/383/382(28/36/40/18/20) [M⁺−2×Cl], 192 (79) [C₁₄H₂₄⁺], 121 (92), 107 (98) [C₈H₁₁⁺], 79 (100).—HRMS (M⁺−Cl, C₁₄H₂₄ClPt): calc. 422.1215; found 422.1213.

### Example 29

### Diiodido-η⁴-((1E,5Z)-1-n-hexylcycloocta-1,5-diene)platinum [PtI₂(nHex-COD)]

The compound was prepared according to the general procedure for the synthesis of platinum complexes of example 2. 53.6 mg (1.00 eq., 0.117 mmol) [PCl₂(nHex-COD)] and 37.7 mg (2.15 eq., 0.251 mmol) NaI in 3 mL acetone were stirred together for three hours. 59.7 mg (0.0931 mmol, 80%) of the desired product could be obtained as an orange wax.—¹H-NMR (400 MHz, CDCl₃): δ (ppm)=0.81 (t, ³J_{HH}=6.8 Hz, 3H, CH₃), 1.19-1.29 (m, 6H, CH₂), 1.35-1.44 (m, 1H, CH₂), 1.67-2.08 (m, 6H, CH₂), 2.10-2.20 (m, 1H, CH₂), 2.33-2.39 (m, 1H, CH₂), 2.48-2.73 (m, 3H, CH₂), 5.46-5.95 (m, 3H, CH).—¹³C-NMR (100 MHz, CDCl₃): δ (ppm)=14.0 (+, CH₃), 22.6 (−, CH₂), 27.8 (−, CH₂), 28.7 (−, CH₂), 29.0 (−, CH₂), 31.4 (−, CH₂), 32.4 (−, CH₂), 32.8 (−, CH₂), 34.9 (−, CH₂), 44.1 (−, CH₂), 99.3 (+, CH), 99.4 (+, CH), 100.7 (+, CH), 133.4 (C_{quart}).—¹⁹⁵Pt-NMR (129 MHz, CDCl₃): δ (ppm)=4261 (s).—IR (KBr) [cm⁻¹]: v⁻¹=3491 (vs), 2952 (s), 2921 (vw), 2852 (s), 1711 (s), 1506 (s), 1454 (s), 1422 (w), 1376 (vs), 1343 (s), 1313 (s), 1237 (s), 1190 (vs), 1168 (s), 1089 (s), 1005 (s), 943 (vs), 864 (s), 827 (s), 801 (m), 723 (m), 622 (m), 585 (vs), 523 (s), 457 (m).—MS (70 eV, El), m/z (%): 642/641/640(39/53/46) [M⁺], 515/514/513(11/15/14) [M⁺−I], 387/386/385/384/383 (73/85/100/44/49) [C₁₄H₂₄Pt⁺], 192 (29) [C₁₄H₂₄⁺].—HRMS (C₁₄H₂₄PtI₂): calc. 640.9616; found 640.9614.

### Example 30

### η⁴-((1E,5Z)-1-n-Hexylcycloocta-1,5-diene)dimethylplatinum [PtMe₂(nHex-COD)]

The compound was prepared according to the general procedure for the synthesis of platinum complexes of example 5. 186 mg (1.00 eq., 0.473 mmol) Pt(acac)₂ and 100 mg (1.10 eq., 0.520 mmol) (1E,5Z)-1-n-butylcycloocta-1,5-diene were dissolved in toluene (18 mL) and 0.712 mL (2 M in toluene, 3.00 eq., 1.42 mmol) AlMe₃ was added dropwise. The reaction mixture was worked up after 24 hours. 172 mg (0.412 mmol, 87%) of the desired product could be obtained as a colorless oil. ¹H-NMR (400 MHz, CDCl₃): δ (ppm)=0.69 (s d, ²J_{PtH}=81.6 Hz, 6H, CH₃), 0.88 (t, ³J=6.6 Hz, 3H, CH₃), 1.21-1.33 (m, 8H, CH₂), 1.56-1.63 (m, 1H, CH₂), 1.85-1.96 (m, 1H, CH₂), 2.04-2.17 (m, 3H, CH₂), 2.21-2.29 (m, 2H, CH₂), 2.36-2.53 (m, 3H, CH₂), 4.65-4.75 (m, 3H, CH).—¹³C-NMR (100 MHz, CDCl₃): δ (ppm)=3.5 (+, s d, ¹J_{Ptc}=765 Hz, PtCH₃), 9.5 (+, s d, ¹J_{Ptc}=778 Hz, PtCH₃), 14.1 (+, CH₃CH₂), 22.6 (−, CH₂), 28.3 (−, CH₂), 29.2 (−, CH₂), 29.3 (−, CH₂), 30.9 (−, CH₂), 31.0 (−, CH₂), 31.7 (−, CH₂), 33.1 (−, CH₂), 40.5 (−, CH₂), 97.5 (+, s d, ¹J_{Ptc}=55.6 Hz, CH), 97.8 (+, s d, ¹J_{Ptc}=59.7 Hz, CH), 99.3 (+, s d, ¹J_{Ptc}=46.2 Hz, CH), 119.8 (s d, ¹J_{Ptc}=55.7 Hz, C_{quart}).—¹⁹⁵Pt-NMR (129 MHz, CDCl₃): δ (ppm)=3527 (s).—IR (ATR) [cm⁻¹]: V⁻¹=3443 (vs), 2924 (vw), 2873 (s), 2798 (vs), 1658 (vs), 1525 (vs), 1480 (vs), 1464 (s), 1432 (vs), 1378 (vs), 1340 (vs), 1315 (vs), 1217 (s), 1197 (vs), 1168 (vs), 1107 (s), 1000 (vs), 866 (s), 788 (vs), 725 (vs), 560 (vs), 540 (s).—MS (70 eV, El), m/z (%): 417 (1) [M⁺], 403/402/401 (22/26/21) [M⁺−CH₃], 389/388/387/386/385/384/383/382/381 (8/9/47/62/100/77/70/21/23) [M⁺−2×CH₃], 79 (6), 43 (9). HRMS (PtC₁₆H₃₀): calc. 417.1996; found 417.1997.

### Example 31

### Thermogravimetric Analysis of Compounds According to the Invention in Comparison with MeCpPtMe₃

Thermogravimetric analysis was performed on a Netzsch TG-209 TGA system and the weight loss rat of the sample was measured. 5 mg of the measured complex was weighed under argon atmosphere into an Al₂O₃ boat and transferred to the TGA system. Thermogravimetric analysis was performed in a nitrogen stream (50 mL/min) and the sample was heated with a heating rate of 10 K/min to a temperature of 100° C. (120° for Me₂Pt(iBu-COD) and 50° C. MeCpPtMe₃) and maintained at this temperature. Then the weight loss rate was measured.

Me₂Pt(n-Et-COD), Me₂Pt(n-Bu-COD), Me₂Pt(1-Bu-COD) and MeCpPtMe₃ were measured. The compounds according to the invention show a continuous and linear weight loss, and they sublimate in a range between 100 and 120° C. MeCpPtMe₃ shows a non-linear weight loss, in particular at the beginning of the sublimation.

The results are shown in FIG. 5.

### Example 32

### Preparation of Pt/SiO₂- Particles by Combination of CVS and MOCVD

The experimental set-up is shown in FIG. 1.

### a) Chemical Vapor Synthesis (CVS) of Sub-Micrometer-Sized SiO₂ Support Particles

In a first step, aerosols of nanometer-sized silica support particles (SiO₂-Particles) were synthesized by decomposition of tetraethyl orthosilicate (TEOS) vapor (c(TEOS)=4.1×10⁻⁵ mol L⁻¹ in a stream of nitrogen gas (300 mL min⁻¹, nominally 99.99%). The to nitrogen is first saturated with TEOS vapor in a temperature-controlled bubbling system (6) at 60° C. The gas/vapor mixture is diluted with air (10) (4 L min⁻¹), and then fed to a CVS Reactor (1) (Carbolite CTF 12/600; ID 12 mm, heated length 600 mm) at 1000° C., where the TEOS decomposes and nucleates to oxide particles. This aerosol is sintered in a sintering tube furnace (2) (Carbolite STF 15/450; ID 25 mm, heated length 450 mm) at 1500° C. to obtain spherical aerosol particles with average Feret diameter of about 70 nm. These sintered spheres provide well-defined surfaces for subsequent TEM image analysis of the coating results. The carrier particle number concentration was 10⁷ cm⁻³ at a total flow rate of 300 mL min⁻¹. The aerosol is finally dried in a diffusion dryer (9) to remove water vapor and then fed to the MOCVD process.

b) Pt Dots Deposition onto the Sub-Micrometer-Sized SiO₂ Support Particles by Metal Organic Chemical Vapor Deposition (MOCVD)

η⁴-((1Z,5Z)-1-ethylcycloocta-1,5-dien)dimethyl platinum [(1-ethyl-COD)PtMe₂], a solid precursor, was stored at −23° C. under argon in a closed flask. For the deposition of Pt dots onto the SiO₂ support particles the precursor was inserted in a glove-box containing a microbalance. Under argon atmosphere 10-12 mg of the precursor was weighed into an Al₂O₃ boat and transferred afterwards in a closed vessel to a precursor sublimator (5). The (1-ethyl-COD)PtMe₂ on the boat is vaporized into a flow of nitrogen (150 ml/min) in the precursor sublimator (5) at 100° C. The precursor vapor is transferred through a heated transfer pipe (7) and then mixed with carrier particle aerosol and fed to the coating reactor (3) at a temperature of 100° C. The coating reactor was made of glass with an inner diameter of 45 mm and a length of 300 mm. Precursor losses were minimized by heating the coating reactor walls to 380° C. The Pt/SiO₂ particles in the resulting Pt/SiO₂ aerosol (4) are collected on a membrane, a TEM grid or can be analyzed via online measuring methods after they pass the coating reactor (3).

The resulting product (SiO₂ particles having platinum dots on their surface) is analyzed by TEM. A TEM photography of one particle having platinum dots on its surface is shown in FIG. 3.

Experiments using dichlorido-η⁴-((1Z,5Z)-1-methylcycloocta-1,5-dien)platinum, diiodido-η⁴-((1Z,5Z)-1-methylcycloocta-1,5-dien)platinum, dimethyl-η⁴-((1Z,5Z)-1-methylcycloocta-1,5-dien)platinum, η⁴-((1Z,5Z)-1-methylcycloocta-1,5-dien)diphenyl platinum, dichlorido-η⁴-((1Z,5Z)-1-ethylcycloocta-1,5-dien)platinum, η⁴-((1Z,5Z)-1-ethylcycloocta-1,5-dien)diiodido platinum, η⁴-((1Z,5Z)-1-ethylcycloocta-1,5-dien)dimethyl platinum, n′-((1Z,5Z)-1-ethylcycloocta-1,5-dien)diphenyl platinum, dichlorido-η⁴-((1E,5Z)-1-phenylcycloocta-1,5-dien)platinum, diiodido-η⁴-((1E,5Z)-1-phenylcycloocta-1,5-dien) platinum, dimethyl-η⁴-((1E,5Z)-1-phenylcycloocta-1,5-dien)platinum, diphenyl-η⁴-((1E,5Z)-1-phenylcycloocta-1,5-dien)platinum, dichlorido-η⁴-((1E,5Z)-1-isopropylcycloocta-1,5-dien)platinum, diiodido-η⁴-((1E,5Z)-1-Isopropylcycloocta-1,5-dien) platinum, η⁴-((1E,5Z)-1-isopropylcycloocta-1,5-dien)dimethyl platinum, η⁴-((1Z,5Z)-1-isopropylcycloocta-1,5-dien)diphenyl platinum, dichlorido-η⁴-((1E,5Z)-1-n-butylcycloocta-1,5-dien)platinum, diiodido-η⁴-((1E,5Z)-1-n-butylcycloocta-1,5-dien)platinum, dimethyl-η⁴-((1E,5Z)-1-n-butylcycloocta-1,5-dien)platinum, diphenyl-η⁴-((1E,5Z)-1-n-butylcycloocta-1,5-dien)platinum, dichlorido-η⁴-((1E,5Z)-1-iso-butylcycloocta-1,5-dien) platinum, diiodido-η⁴-((1E,5Z)-1-iso-butylcycloocta-1,5-dien)platinum, dimethyl-η⁴-((1E,5Z)-1-iso-butylcycloocta-1,5-dien)platinum, diphenyl-η⁴-((1E,5Z)-1-iso-butylcycloocta-1,5-dien)platinum, dichlorido-η⁴-((1E,5Z)-1-n-hexylcycloocta-1,5-diene)platinum, diiodido-η⁴-((1E,5Z)-1-n-hexylcycloocta-1,5-diene)platinum, and η⁴-((1E,5Z)-1-n-hexylcycloocta-1,5-diene)dimethylplatinum as precursor show similar results.

### Example 33

### Preparation of Pt/SiO₂-Particles by MOCVD

The experimental set-up is shown in FIG. 2.

Pt dots deposition onto sub-micrometer-sized SiO₂ support particles by metal organic chemical vapor deposition (MOCVD)

(1-ethyl-COD)PtMe₂, a solid precursor, was stored at −23° C. under argon in a closed flask. For the deposition of Pt dots onto the SiO₂ support particles the precursor was inserted into a glove-box containing a microbalance. Under argon atmosphere 10-12 mg of the precursor was weighed into an Al₂O₃ boat and transferred afterwards in a closed vessel to a precursor sublimator (5). The (1-ethyl-COD)PtMe₂ in the boat is vaporized into a flow of nitrogen (150 ml/min) in the precursor sublimator (5) at 100° C. The precursor vapor is transferred through a heated transfer pipe (7) and then mixed with a carrier particle (300 mL min⁻¹; N₂ and SiO₂ particles with a average Feret diameter of 70 nm) aerosol (8) and fed to the coating reactor (3) at a temperature of 100° C. The coating reactor was made of glass with an inner diameter of 45 mm and a length of 300 mm. Precursor losses were minimized by heating the coating reactor walls to 380° C. The Pt/SiO₂ particles in the resulting Pt/SiO₂ aerosol (4) are collected on a membrane, a TEM grid or can by analyzed via online measuring methods after they pass the coating reactor (3).

The resulting product (SiO₂ particles having platinum dots on their surface) is analyzed be TEM. The TEM photography of one particle having platinum dots on its surface is similar to the TEM photography as shown in FIG. 3.

Experiments using dichlorido-η⁴-((1Z,5Z)-1-methylcycloocta-1,5-dien)platinum, diiodido-η⁴-((1Z,5Z)-1-methylcycloocta-1,5-dien)platinum, dim ethyl-η⁴-((1Z,5Z)-1-methylcycloocta-1,5-dien)platinum, η⁴-((1Z,5Z)-1-methylcycloocta-1,5-dien)diphenyl platinum, dichlorido-η⁴-((1Z,5Z)-1-ethylcycloocta-1,5-dien)platinum, η⁴-((1Z,5Z)-1-ethylcycloocta-1,5-dien)diiodido platinum, η⁴-((1Z,5Z)-1-ethylcycloocta-1,5-dien)dimethyl platinum, η⁴-((1Z,5Z)-1-ethylcycloocta-1,5-dien)diphenyl platinum, dichlorido-η⁴-((1E,5Z)-1-phenylcycloocta-1,5-dien)platinum, diiodido-η⁴-((1E,5Z)-1-phenylcycloocta-1,5-dien) platinum, dimethyl-η⁴-((1E,5Z)-1-phenylcycloocta-1,5-dien)platinum, diphenyl-η⁴-((1E,5Z)-1-phenylcycloocta-1,5-dien)platinum, dichlorido-η⁴-((1E,5Z)-1-isopropylcycloocta-1,5-dien)platinum, diiodido-η⁴-((1E,5Z)-1-Isopropylcycloocta-1,5-dien) platinum, η⁴-((1E,5Z)-1-isopropylcycloocta-1,5-dien)dimethyl platinum, η⁴-((1Z,5Z)-1-isopropylcycloocta-1,5-dien)diphenyl platinum, dichlorido-η⁴-((1E,5Z)-1-n-butylcycloocta-1,5-dien)platinum, diiodido-η⁴-((1E,5Z)-1-n-butylcycloocta-1,5-dien)platinum, dimethyl-η⁴-((1E,5Z)-1-n-butylcycloocta-1,5-dien)platinum, diphenyl-η⁴-((1E,5Z)-1-n-butylcycloocta-1,5-dien)platinum, dichlorido-η⁴-((1E,5Z)-1-iso-butylcycloocta-1,5-dien) platinum, diiodido-η⁴-((1E,5Z)-1-iso-butylcycloocta-1,5-dien)platinum, dimethyl-η⁴-((1E,5Z)-1-iso-butylcycloocta-1,5-dien)platinum, diphenyl-η⁴-((1E,5Z)-1-iso-butylcycloocta-1,5-dien)platinum, dichlorido-η⁴-((1E,5Z)-1-n-hexylcycloocta-1,5-diene)platinum, diiodido-η⁴-((1E,5Z)-1-n-hexylcycloocta-1,5-diene)platinum, and η⁴-((1E,5Z)-1-n-hexylcycloocta-1,5-diene)dimethylplatinum as precursor show similar results.

### Example 34

### Preparation of Pt/TiO₂-Particles by Combination of CVS and MOCVD

The experimental set-up is shown in FIG. 1.

### a) Chemical Vapor Synthesis (CVS) of Sub-Micrometer-Sized TiO₂ Support Particles

In a first step, aerosols of nanometer-sized TiO₂ support particles (TiO₂-Particles) were synthesized by decomposition of titanium(IV)isopropoxide (TTIP) vapor (c(TTIP)=4.1×10⁻⁵ mol L⁻¹ in a stream of nitrogen gas (300 mL min⁻¹, nominally 99.99%). The nitrogen is first saturated with TTIP vapor in a temperature-controlled bubbling system (6) at 60° C. The gas/vapor mixture is diluted with air (10) (4 L min⁻¹), and then fed to a CVS Reactor (1) (Carbolite CTF 12/600; ID 12 mm, heated length 600 mm) at 1000° C., where the TTIP decomposes and nucleates to oxide particles. This aerosol is sintered in a sintering tube furnace (2) (Carbolite STF 15/450; ID 25 mm, heated length 450 mm) at 1500° C. to obtain spherical aerosol particles with average Feret diameter of about 80 nm. These sintered spheres provide well-defined surfaces for subsequent TEM image analysis of the coating results. The carrier particle number concentration was 10⁷ cm⁻³ at a total flow rate of 300 mL min⁻¹. The aerosol is finally dried in a diffusion dryer (9) to remove water vapor and then fed to the MOCVD process.

b) Pt Dots Deposition onto the Sub-Micrometer-Sized TiO₂ Support Particles by Metal Organic Chemical Vapor Deposition (MOCVD)

η⁴-((1Z,5Z)-1-ethylcycloocta-1,5-dien)dimethyl platinum [(1-ethyl-COD)PtMe₂], a solid precursor, was stored at −23° C. under argon in a closed flask. For the deposition of Pt dots onto the TiO2 support particles the precursor was inserted in a glove-box containing a microbalance. Under argon atmosphere 10-12 mg of the precursor was weighed into an Al₂O₃ boat and transferred afterwards in a closed vessel to a precursor sublimator (5). The (1-ethyl-COD)PtMe₂ onto the boat is vaporized into a flow of nitrogen (150 ml/min) in the precursor sublimator (5) at 100° C. The precursor vapor is transferred through a heated transfer pipe (7) and then mixed with carrier particle aerosol and fed to the coating reactor (3) at a temperature of 100° C. The coating reactor was made of glass with an inner diameter of 45 mm and a length of 300 mm. Precursor losses were minimized by heating the coating reactor walls to 380° C. The Pt/TiO₂ particles in the resulting Pt/TiO2 aerosol (4) are collected on a membrane, a TEM grid or can be analyzed via online measuring methods after they pass the coating reactor (3).

Experiments using dichlorido-η⁴-((1Z,5Z)-1-methylcycloocta-1,5-dien)platinum, diiodido-η⁴-((1Z,5Z)-1-methylcycloocta-1,5-dien)platinum, dimethyl-η⁴-((1Z,5Z)-1-methylcycloocta-1,5-dien)platinum, η⁴-((1Z,5Z)-1-methylcycloocta-1,5-dien)diphenyl platinum, dichlorido-η⁴-((1Z,5Z)-1-ethylcycloocta-1,5-dien)platinum, η⁴-((1Z,5Z)-1-ethylcycloocta-1,5-dien)diiodido platinum, η⁴-((1Z,5Z)-1-ethylcycloocta-1,5-dien)dimethyl platinum, n′-((1Z,5Z)-1-ethylcycloocta-1,5-dien)diphenyl platinum, dichlorido-η⁴-((1E,5Z)-1-phenylcycloocta-1,5-dien)platinum, diiodido-η⁴-((1E,5Z)-1-phenylcycloocta-1,5-dien) platinum, dimethyl-η⁴-((1E,5Z)-1-phenylcycloocta-1,5-dien)platinum, diphenyl-η⁴-((1E,5Z)-1-phenylcycloocta-1,5-dien)platinum, dichlorido-η⁴-((1E,5Z)-1-isopropylcycloocta-1,5-dien)platinum, diiodido-η⁴-((1E,5Z)-1-Isopropylcycloocta-1,5-dien) platinum, η⁴-((1E,5Z)-1-isopropylcycloocta-1,5-dien)dimethyl platinum, η⁴-((1Z,5Z)-1-isopropylcycloocta-1,5-dien)diphenyl platinum, dichlorido-η⁴-((1E,5Z)-1-n-butylcycloocta-1,5-dien)platinum, diiodido-η⁴-((1E,5Z)-1-n-butylcycloocta-1,5-dien)platinum, dimethyl-η⁴-((1E,5Z)-1-n-butylcycloocta-1,5-dien)platinum, diphenyl-η⁴-((1E,5Z)-1-n-butylcycloocta-1,5-dien)platinum, dichlorido-η⁴-((1E,5Z)-1-iso-butylcycloocta-1,5-dien) platinum, diiodido-η⁴-((1E,5Z)-1-iso-butylcycloocta-1,5-dien)platinum, dimethyl-η⁴-((1E,5Z)-1-iso-butylcycloocta-1,5-dien)platinum, diphenyl-η⁴-((1E,5Z)-1-iso-butylcycloocta-1,5-dien)platinum, dichlorido-η⁴-((1E,5Z)-1-n-hexylcycloocta-1,5-diene)platinum, diiodido-η⁴-((1E,5Z)-1-n-hexylcycloocta-1,5-diene)platinum, and η⁴-((1E,5Z)-1-n-hexylcycloocta-1,5-diene)dimethylplatinum as precursor show similar results.

### Example 35

### Pt/SiO₂-Particles

An aerosol of nanometer-sized silica support particles (SiO₂-Particles; substrate) were synthesized according to the process described in Example 32. Precursor vapor for MOCVD is prepared according to the process described in Example 32.

The experimental set-up is shown in FIG. 6.

### Alternative a)

The synthesized nanometer-sized silica support particles (SiO₂-Particles) are fluidized in a fluidized bed reactor (14) and the vaporized metal organic precursor is subsequently transferred through a heated transfer pipe (7) to the fluidized bed reactor (14).

For this (1-ethyl-COD)PtMe₂, a solid precursor, was stored at −23° C. under argon in a closed flask. For the deposition of Pt dots onto the SiO₂ support particles the precursor was inserted into a glove-box containing a microbalance. Under argon atmosphere 10-12 mg of the precursor was weighed into an Al₂O₃ boat and transferred afterwards in a closed vessel to a precursor sublimator (5). The (1-ethyl-COD)PtMe₂ in the boat is vaporized into a flow of nitrogen (150 ml/min) in the precursor sublimator (5) at 100° C. The fluidized bed reactor (14) had an inner diameter of 70 mm and a height of 800 cm and was electrically heated. The reaction temperature can be varied in the range of 50 to 500° C. The main fluidization flow entered the reactor through a glass frit at the bottom end and was varied between 2 and 20 l/min. Fluidization requires the break-up of large agglomerates, which can be achieved by vibration, a small (0.2-1 l/min) but high velocity (10-100 m/s) gas flow produced by a small orifice (200-600 μm) mounted to a lance (15) which is inserted into the particle bed, or other measures. Intensive intermixing of the fluidized particles ensures a uniform distribution of the vaporized metal organic precursor in the fluidized bed reactor (14) and a uniform distribution of vaporized metal organic precursor on the surface of the particles through adsorption.

Preconditioning of particles by adjustment of the OH-group concentration and the addition of reactive gases such as oxygen or hydrogen (1-5% by Volume) lead to a decomposition of the precursors on the support, so as to form platinum dots in a single step. The crucial parameters for product control (i.e. for controlling structure and shape of product particles comprising platinum dots on silica support particles, for controlling the size distribution and number of platinum dots on the particle surfaces, etc.) are the concentration of the platinum precursor (1-100 ppm), the coating duration (2-60 min), the reaction temperature (50-500° C.), and the OH-group concentration of the particle surface (2-15 groups/nm²). The concentration of OH groups on the surface can be adjusted by treating the particles in a fluidized bed reactor with water vapor or dry inert gases. For a reduction of the OH group concentration heating in inert gases at 300-500° C. for 10-60 min was carried out. To increase the OH-group concentration, treatment of the oxide powders in water vapor (1-5% by Volume) at temperatures ranging from 200-500° C. was carried out. The determination of OH-group concentration can be done by thermogravimetric analysis, Si-NMR, H-NMR or by titration.

Experiments using dichlorido-η⁴-((1Z,5Z)-1-methylcycloocta-1,5-dien)platinum, diiodido-η⁴-((1Z,5Z)-1-methylcycloocta-1,5-dien)platinum, dim ethyl-η⁴-((1Z,5Z)-1-methylcycloocta-1,5-dien)platinum, η⁴-((1Z,5Z)-1-methylcycloocta-1,5-dien)diphenyl platinum, dichlorido-η⁴-((1Z,5Z)-1-ethylcycloocta-1,5-dien)platinum, η⁴-((1Z,5Z)-1-ethylcycloocta-1,5-dien)diiodido platinum, η⁴-((1Z,5Z)-1-ethylcycloocta-1,5-dien)dimethyl platinum, η′-((1Z,5Z)-1-ethylcycloocta-1,5-dien)diphenyl platinum, dichlorido-η⁴-((1E,5Z)-1-phenylcycloocta-1,5-dien)platinum, diiodido-η⁴-((1E,5Z)-1-phenylcycloocta-1,5-dien)platinum, dimethyl-η⁴-((1E,5Z)-1-phenylcycloocta-1,5-dien)platinum, diphenyl-η⁴-((1E,5Z)-1-phenylcycloocta-1,5-dien)platinum, dichlorido-η⁴-((1E,5Z)-1-isopropylcycloocta-1,5-dien)platinum, diiodido-η⁴-((1E,5Z)-1-Isopropylcycloocta-1,5-dien) platinum, η⁴-((1E,5Z)-1-isopropylcycloocta-1,5-dien)dimethyl platinum, η⁴-((1Z,5Z)-1-isopropylcycloocta-1,5-dien)diphenyl platinum, dichlorido-η⁴-((1E,5Z)-1-n-butylcycloocta-1,5-dien)platinum, diiodido-η⁴-((1E,5Z)-1-n-butylcycloocta-1,5-dien)platinum, dimethyl-η⁴-((1E,5Z)-1-n-butylcycloocta-1,5-dien)platinum, diphenyl-η⁴-((1E,5Z)-1-n-butylcycloocta-1,5-dien)platinum, dichlorido-η⁴-((1E,5Z)-1-iso-butylcycloocta-1,5-dien) platinum, diiodido-η⁴-((1E,5Z)-1-iso-butylcycloocta-1,5-dien)platinum, dimethyl-η⁴-((1E,5Z)-1-iso-butylcycloocta-1,5-dien)platinum, diphenyl-η⁴-((1E,5Z)-1-iso-butylcycloocta-1,5-dien)platinum, dichlorido-η⁴-((1E,5Z)-1-n-hexylcycloocta-1,5-diene)platinum, diiodido-η⁴-((1E,5Z)-1-n-hexylcycloocta-1,5-diene)platinum, and η⁴-((1E,5Z)-1-n-hexylcycloocta-1,5-diene)dimethylplatinum as precursor show similar results.

### Alternative b)

In a variation of alternative a) the CVD process is carried out in two steps. The absorption of the vaporized metal organic precursor is carried out in a first step and the decomposition reaction is carried out in a second step.

In the first step the synthesized nanometer-sized silica support particles (SiO₂-Particles) are fluidized in a fluidized bed reactor (14) and the vaporized metal organic precursor is subsequently transferred through a heated transfer pipe (7) into the fluidized bed reactor (14). For this (1-ethyl-COD)PtMe₂, a solid precursor, was stored at −23° C. under argon in a closed flask. The precursor was inserted into a glove-box containing a microbalance. Under argon atmosphere 10-12 mg of the precursor was weighed into an Al₂O₃ boat and transferred afterwards in a closed vessel to a precursor sublimator (5). The (1-ethyl-COD)PtMe₂ in the boat is vaporized into a flow of nitrogen (150 ml/min) in the precursor sublimator (5) at 100° C.

The fluidized bed reactor (14) had an inner diameter of 70 mm and a height of 800 cm and was electrically heated. The reaction temperature can be varied in the range of 50 to 500° C. The main fluidization flow entered the reactor through a glass frit at the bottom end and was varied between 2 and 20 l/min. Fluidization requires the break-up of large agglomerates, which can be achieved by vibration, a small (0.2-1 l/min) but high velocity (10-100 m/s) gas flow produced by a small orifice (200-600 μm) mounted to a lance (15) which is inserted into the particle bed, or other measures. Intensive intermixing of the fluidized particles ensures a uniform distribution of the vaporized metal organic precursor in the fluidized bed reactor (14) and a uniform distribution of vaporized metal organic precursor on the surface of the particles through adsorption.

The absorption can be monitored with appropriate measurement methods (FTIR, GC, MS) in the effluent gas from the fluidized bed reactor (14). After saturation of the particle surfaces with the metal organic precursor, the fluidized bed reactor (14) is flushed with an inert gas to remove metal organic precursors that are not adsorbed. Afterwards a reactive gas such as water vapor (1-10% by volume in inert gas) is added to the carrier gas flow which prompts the decomposition of the metal organic precursor and initiates the formation of (three-dimensional) dots. The process in two steps allows an adsorption and a reaction under different pressure and temperature conditions, so that the surface structure can be manipulated in different ways.

Experiments using dichlorido-η⁴-((1Z,5Z)-1-methylcycloocta-1,5-dien)platinum, diiodido-η⁴-((1Z,5Z)-1-methylcycloocta-1,5-dien)platinum, dim ethyl-η⁴-((1Z,5Z)-1-methylcycloocta-1,5-dien)platinum, η⁴-((1Z,5Z)-1-methylcycloocta-1,5-dien)diphenyl platinum, dichlorido-η⁴-((1Z,5Z)-1-ethylcycloocta-1,5-dien)platinum, η⁴-((1Z,5Z)-1-ethylcycloocta-1,5-dien)diiodido platinum, η⁴-((1Z,5Z)-1-ethylcycloocta-1,5-dien)dimethyl platinum, η′-((1Z,5Z)-1-ethylcycloocta-1,5-dien)diphenyl platinum, dichlorido-η⁴-((1E,5Z)-1-phenylcycloocta-1,5-dien)platinum, diiodido-η⁴-((1E,5Z)-1-phenylcycloocta-1,5-dien) platinum, dimethyl-η⁴-((1E,5Z)-1-phenylcycloocta-1,5-dien)platinum, diphenyl-η⁴-((1E,5Z)-1-phenylcycloocta-1,5-dien)platinum, dichlorido-η⁴-((1E,5Z)-1-isopropylcycloocta-1,5-dien)platinum, diiodido-η⁴-((1E,5Z)-1-Isopropylcycloocta-1,5-dien) platinum, η⁴-((1E,5Z)-1-isopropylcycloocta-1,5-dien)dimethyl platinum, η⁴-((1Z,5Z)-1-isopropylcycloocta-1,5-dien)diphenyl platinum, dichlorido-η⁴-((1E,5Z)-1-n-butylcycloocta-1,5-dien)platinum, diiodido-η⁴-((1E,5Z)-1-n-butylcycloocta-1,5-dien)platinum, dimethyl-η⁴-((1E,5Z)-1-n-butylcycloocta-1,5-dien)platinum, diphenyl-η⁴-((1E,5Z)-1-n-butylcycloocta-1,5-dien)platinum, dichlorido-η⁴-((1E,5Z)-1-iso-butylcycloocta-1,5-dien) platinum, diiodido-η⁴-((1E,5Z)-1-iso-butylcycloocta-1,5-dien)platinum, dimethyl-η⁴-((1E,5Z)-1-iso-butylcycloocta-1,5-dien)platinum, diphenyl-η⁴-((1E,5Z)-1-iso-butylcycloocta-1,5-dien)platinum, dichlorido-η⁴-((1E,5Z)-1-n-hexylcycloocta-1,5-diene)platinum, diiodido-η⁴-((1E,5Z)-1-n-hexylcycloocta-1,5-diene)platinum, and η⁴-((1E,5Z)-1-n-hexylcycloocta-1,5-diene)dimethylplatinum as precursor show similar results.

### Example 36

### Synthesis of Pt-Nanoparticles by Fixed Bed MOCVD

The experimental setup is shown in FIG. 7.

For a standard coating experiment 50 to 70 mg of commercial nanoscale support particles (e.g. from Evonik) were filled inside the reactor. The average primary particle size diameters (dₛᵤₚₚₒᵣₜ) of the support nanoparticles are in the range of from 12 to 40 nm (see Table 1 below, also for additional nanoparticle characteristics). In order to remove all of the physisorbed water on the support nanoparticle surfaces, the fixed bed was heated to 150° C. for 1 h under flowing nitrogen. Subsequently the precursor MeCpPtMe₃ was introduced into the fixed bed which was held at 150° C. Precursor evaporation at 40° C. and a N₂ stream of 50 ml/min were applied. After an exposure to the precursor of 30 min, both three way valves were switched over and the organic ligands were oxidative removed for 30 min at 300° C. and 30 ml/min O₂. Afterwards the support nanoparticles were again treated with precursor or oxygen, cyclically switched until the entire precursor (8 mg) was consumed, while a time of exposure of 30 min was chosen.

Results of the above described fixed bed MOCVD:

The results of Example 36 are shown below in Table 1, and FIGS. 8 and 9.

The following abbreviations and terms are used in Table 1 below:
“Support” material used as substrate
“d_{Support}” average primary particle size diameter of the material used as substrate
“OH-density” density of hydroxyl groups on the surface of the support
“d_{Pt}” median particle size diameter of the Pt-particles deposited on the substrate surfaces
“Dispersion” molar fraction of exposed Pt

TEM observation showed narrow size distributions for the platinum nanoparticles on the metal oxide support.

Very small median particle size diameters of 1.9 nm and a high dispersion of 58% were measured for Pt—Al₂O₃ synthesized by fixed bed MOCVD (see Table 1, FIGS. 8 and 9A).

The Pt-islands synthesized on TiO₂ (P25) (see FIG. 9B) and silica (see FIG. 9C) were also narrowly distributed but larger in size (4 to 5 nm, respectively, see Table 1).

This difference in median particle size diameter (d_{Pt}) may be the result of different properties of the support particle surface. XPS measurements complete the observation on the particles produced by fixed bed MOCVD. The presence of Pt⁰, Pt²⁺ and Pt⁴⁺ was observed by XPS. The binding energies measured for platinum (Pt 4f_{7/2}=71.2 eV/Pt⁰, 72.8 eV/Pt²⁺; and 74.5 eV/Pt⁴⁺) are in a good agreement with reference data and close to those reported in the literature.

TABLE 1
Properties of support and platinum particles
produced by fixed bed MOCVD.

| | | | | OH— | | |
|---|---|---|---|---|---|---|
| | dₛᵤₚₚₒᵣₜ | Lewis- | BET* | density* | d_{Pt} | Disper- |
| Support | nm | Acidity* | m²/g | 1/nm² | nm | sion % |
| Aeroxide Alu | 13 | weak base | 100 ± 15 | 8.5-9.2 | 1.9 | 58 |
| C (Al₂O₃) | | | | | | |
| Aeroxide P25 | 21 | acid/base | 50 ± 15 | 5 | 4.2 | 26 |
| (TiO₂) | | | | | | |
| Aerosil Ox50 | 40 | acid | 50 ± 15 | 2.1 | 4.7 | 23 |
| (SiO₂) | | | | | | |
| Aerosil 200 | 12 | acid | 200 ± 25 | 2.7 | 4.6 | 24 |
| (SiO₂) | | | | | | |

*given by the producer (Evonik)

The dispersion D (the molar fraction of exposed Pt) was calculated from the particle size using the equation given by Anderson^{#} (and multiplied by 100 in order to obtain values in percent):

$$D = 6 \cdot ( \frac{{υ}_{{p}_{t}}}{{a}_{{p}_{t}}} ) / {d}_{{p}_{t}}$$

with the effective average area occupied by a Pt-atom in the surface a_{Pt} of 0.0807 nm² and with the volume per Pt-atom in the bulk of ν_{Pt}, of 0.01506 nm³. ^{#}J. R. Anderson, “Measurement Techniques: Surface Area, Particle Size and Pore Structure” in Structure of metal catalysts, Academic Press Inc, London, UK, 1975, Chpt. 6, pp. 296 and 360

### Comparative Example 1

### Pt/SiO₂-Particles

The particles were prepared according to the procedure defined in example 32 above, with the exception that instead of η⁴-((1Z,5Z)-1-ethylcycloocta-1,5-dien)dimethyl platinum (Trimethyl)methylcylopendadienylplatinum was used as a precursor.

The resulting product (SiO₂ particles having platinum dots on their surface) is analyzed by TEM. A TEM photography of one particle having platinum dots on its surface is shown in FIG. 4.

A comparison of FIGS. 3 and 4 shows that the method of example 22 in which a compound of the present invention is used as a precursor results in particles having dots with narrow size distribution, typical dot diameters being below 5 nm. In contrast, the method of comparative example 1 in which a compound is used as a precursor which is not a compound of the present invention results in particles having comparatively large dots with a broad size distribution.

The product of the present invention as depicted in FIG. 3 can be used as a catalyst or as catalytically active component of a catalyst system. The product is characterized by a large platinum surface area achieved with a low mass of platinum deposited, i.e. the ratio of platinum surface area to platinum mass deposited is particularly favorable.

1. A compound of general formula (I) 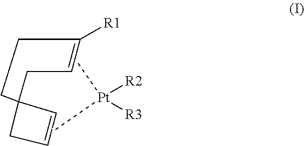
wherein
R1 represents a moiety selected from the group consisting of methyl, ethyl, n-propyl, isopropyl, n-butyl, sec-butyl, tert-butyl, linear or branched, saturated or mono- or polyunsaturated aliphatic carbon chain containing from two to ten carbon atoms, phenyl, and phenylacetylene,
and wherein
R2 and R3 independently of each other represent a moiety selected from the group consisting of Cl, I, methyl, phenyl, and phenylacetylene.

2. The compound according to claim 1, wherein R2 and R3 are identical and each represents a moiety selected from the group consisting of Cl, I, methyl, phenyl, and phenylacetylene.

3. The compound according to claim 1, wherein the compound of the general formula (I) is a compound selected from the group consisting of dichlorido-η⁴-((1Z,5Z)-1-methylcycloocta-1,5-dien)platinum, diiodido-η⁴-((1Z,5Z)-1-methylcycloocta-1,5-dien)platinum, dimethyl-η⁴-((1Z,5Z)-1-methylcycloocta-1,5-dien)platinum, η⁴-((1Z,5Z)-1-methylcycloocta-1,5-dien)diphenyl platinum, dichlorido-η⁴-((1Z,5Z)-1-ethylcycloocta-1,5-dien)platinum, η⁴-((1Z,5Z)-1-ethylcycloocta-1,5-dien)diiodido platinum, η⁴-((1Z,5Z)-1-ethylcycloocta-1,5-dien)dimethyl platinum, η⁴-((1Z,5Z)-1-ethylcycloocta-1,5-dien)diphenyl platinum, dichlorido-η⁴-((1E,5Z)-1-phenylcycloocta-1,5-dien)platinum, diiodido-η⁴-((1E,5Z)-1-phenylcycloocta-1,5-dien)platinum, dimethyl-η⁴-((1E,5Z)-1-phenylcycloocta-1,5-dien)platinum, diphenyl-η⁴-((1E,5Z)-1-phenylcycloocta-1,5-dien)platinum, dichlorido-η⁴-((1E,5Z)-1-isopropylcycloocta-1,5-dien)platinum, diiodido-η⁴-((1E,5Z)-1-Isopropylcycloocta-1,5-dien)platinum, η⁴-((1E,5Z)-1-isopropylcycloocta-1,5-dien)dimethyl platinum, η⁴-((1Z,5Z)-1-isopropylcycloocta-1,5-dien)diphenyl platinum, dichlorido-η⁴-((1E,5Z)-1-n-butylcycloocta-1,5-dien)platinum, diiodido-η⁴-((1E,5Z)-1-n-butylcycloocta-1,5-dien)platinum, dimethyl-η⁴-((1E,5Z)-1-n-butylcycloocta-1,5-dien)platinum, diphenyl-η⁴-((1E,5Z)-1-n-butylcycloocta-1,5-dien)platinum, dichlorido-η⁴-((1E,5Z)-1-iso-butylcycloocta-1,5-dien)platinum, diiodido-η⁴-((1E,5Z)-1-iso-butylcycloocta-1,5-dien)platinum, dimethyl-η⁴-((1E,5Z)-1-iso-butylcycloocta-1,5-dien)platinum, diphenyl-η⁴-((1E,5Z)-1-iso-butylcycloocta-1,5-dien)platinum, dichlorido-η⁴-((1E,5Z)-1-n-hexylcycloocta-1,5-diene)platinum, diiodido-η⁴-((1E,5Z)-1-n-hexylcycloocta-1,5-diene)platinum, and η⁴-((1E,5Z)-1-n-hexylcycloocta-1,5-diene)dimethylplatinum.

4. A method for depositing platinum onto a substrate in a metal organic chemical vapor deposition process, wherein the compound according to claim 1 is used as a precursor for depositing the platinum onto the substrate.

5. The method according to claim 4, wherein the substrate comprises (a) one or more oxides selected from the group consisting of SiO₂, MgO, Al₂O₃, TiO₂, ZrO₂, Y₂O₃, Cr₂O₃, La₂O₃, Fe₂O₃, ZnO, and SnO and/or (b) one or more mixed oxides of two, three or more oxides selected from the group consisting of SiO₂, MgO, Al₂O₃, TiO₂, ZrO₂, Y₂O₃, Cr₂O₃, La₂O₃, Fe₂O₃, ZnO, and SnO.

6. The method according to claim 4, wherein the substrate comprises particles having an average Feret diameter in the range of from 12 to 300 nm, in the range of from 25 to 200 nm, or in the range of from 40 to 100 nm.

7. The method according to claim 6, wherein the substrate comprises particles selected from the group consisting of cylindrical, discoidal, tabular, ellipsoidal, equant, irregular, and spherical particles.

8. The method according to claim 4, wherein one or more platinum dots are deposited onto the substrate.

9. The method according to claim 8, wherein at least some of the platinum dots deposited on the substrate have a mean Feret diameter below 10 nm, in the range of from 0.5 to 8 nm, or in the range of from 1 to 4 nm.

10. The method according to claim 9, wherein at least 90% of platinum dots having a minimum mean Feret diameter of 1 nm have a mean Feret diameter in the range of from 1 to 4 nm.

11. The method according to claim 4, wherein the metal organic chemical vapor deposition process is performed partly or completely under a pressure in the range of from 1 mbar to 2000 mbar, in the range of from 500 mbar to 1500 mbar, or in the range of from 900 mbar to 1200 mbar.

12. A method for depositing platinum onto a substrate comprising contacting the compound of formula (I) according to claim 1 with a substrate under conditions in which the compound of formula (I) decomposes into metallic platinum.

13. A product comprising a quantity of particles having platinum dots on their surface,
wherein the particles having platinum dots on their surface, without consideration of the platinum dots, have a mean Feret diameter in the range of from 12 to 300 nm, in the range of from 25 to 200 nm, or in the range of from 40 to 100 nm, and
wherein the platinum dots have a mean Feret diameter below 10 nm, in the range of from 0.5 to 8 nm, or in the range of from 1 to 4 nm.

14. The product according to claim 13, wherein at least 90% of platinum dots having a minimum diameter of 1 nm have a diameter in the range of from 1 to 4 nm.

15. The product according to claim 13, wherein the particles have at least 1 dot per 100 nm², at least 4 dots per 100 nm², or at least 6 dots per 100 nm² of the particle surface.

16. The product according to claim 13, wherein the substrate comprises (a) one or more oxides selected from the group consisting of SiO₂, MgO, Al₂O₃, TiO₂, ZrO₂, Y₂O₃, Cr₂O₃, La₂O₃, Fe₂O₃, ZnO, and SnO and/or (b) one or more mixed oxides of two, three or more oxides selected from the group consisting of SiO₂, MgO, Al₂O₃, TiO₂, ZrO₂, Y₂O₃, Cr₂O₃, La₂O₃, Fe₂O₃, ZnO, and SnO.

17. The product according to claim 13, wherein the substrate having one or more platinum dots on its surface is produced by a metal organic chemical vapor deposition process.

18. The product according to claim 17, wherein a compound of formula (I) 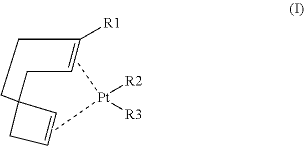
wherein
R1 represents a moiety selected from the group consisting of methyl, ethyl, n-propyl, isopropyl, n-butyl, sec-butyl, tert-butyl, linear or branched, saturated or mono- or polyunsaturated aliphatic carbon chain containing from two to ten carbon atoms, phenyl, and phenylacetylene,
and wherein
R2 and R3 independently of each other represent a moiety selected from the group consisting of Cl, I, methyl, phenyl, and phenylacetylene
is used as precursor in the metal organic chemical vapor deposition process to form the platinum dot(s).

19. A catalyst system for a catalytic converter or for asymmetric hydrogenation, comprising a product according to claim 13.

20. A method for catalytic conversion or asymmetric hydrogenation comprising a product according to claim 13 as a catalyst.
